(19) United States
(12) Patent Application Publication
(10) Pub. No.: US 2010/0281003 A1
(43) Pub. Date: Nov. 4, 2010

(54) SYSTEM AND USES FOR GENERATING DATABASES OF PROTEIN SECONDARY STRUCTURES INVOLVED IN INTER-CHAIN PROTEIN INTERACTIONS

(75) Inventors: Andrea L. JOCHIM, New York, NY (US); Paramjit S. ARORA, White Plains, NY (US)

Correspondence Address: NIXON PEABODY LLP - PATENT GROUP, 1100 CLINTON SQUARE, ROCHESTER, NY, 14604, US

(73) Assignee: NEW YORK UNIVERSITY, New York, NY (US)

(21) Appl. No.: 12/753,638

(22) Filed: Apr. 2, 2010

Related U.S. Application Data
(60) Provisional application No. 61/166,211, filed on Apr. 2, 2009.

(51) Int. Cl. G06F 17/30

(52) U.S. Cl. 707/692; 707/740; 707/E17.046; 707/E17.014

(57) ABSTRACT

The present invention relates to methods and systems for generating a database of protein secondary structures that are at an interface of a two-chain inter-protein interaction. Collections of secondary structures identified according to the methods disclosed herein, and their use in identifying therapeutic drug candidates potentially effective in modulating a two-chain inter-protein interaction having a secondary structure at its interface, are also disclosed.

This application claims the priority benefit of U.S. Provisional Patent Application Ser. No. 61/166,211, filed Apr. 2, 2009, which is hereby incorporated by reference in its entirety.

This invention was made with government support under grant number GM073943 awarded by the National Institutes of Health. The government has certain rights in this invention.

### FIELD OF THE INVENTION

The present invention relates to methods and systems for generating a database of protein secondary structures that are at an interface of a two-chain inter-protein interaction. Collections of the secondary structures that are at the interface of inter-protein interactions and methods of screening are also disclosed.

### BACKGROUND OF THE INVENTION

A fundamental limitation of current drug development centers on the inability of traditional pharmaceuticals to target spatially extended protein interfaces. The majority of modern pharmaceuticals are small molecules that target enzymes or protein receptors with defined pockets. However, in general they cannot target protein-protein interactions involving large contact areas with the required specificity. Recent computational and experimental studies highlight the “hot-spots” on protein surfaces that contribute significantly to binding interactions (Clackson et al., “A Hot-Spot of Binding-Energy in a Hormone-Receptor Interface,” Science 267:383-386 (1995); Guney et al., “HotSprint: Database of Computational Hot Spots in Protein Interfaces,” Nucleic Acids Res. 36:D662-D666 (2008); Keskin et al., “Principles of Protein-Protein Interactions: What Are the Preferred Ways for Proteins to Interact?,” Chem. Rev. 108:1225-1244 (2008); Wells et al., “Reaching for High-Hanging Fruit in Drug Discovery at Protein-Protein Interfaces,” Nature 450:1001-1009 (2007)). Hot-spot residues are those residues at the protein interface that contribute to high affinity binding and are usually surrounded by energetically less important residues. Typically, the first step in developing a small molecule inhibitor to target a protein interface is to identify hot-spot residues responsible for protein-complex recognition. Subsequently, the topography of these side chains is reproduced by similar peptidic or non-peptidic functionalities on a scaffold that positions the crucial recognition elements correctly. Thus, protein-protein recognition may be concentrated in a few key residues arranged in a particular three-dimensional shape.

Selective modulation of protein-protein interactions is a grand challenge for chemical biologists and medicinal chemists (Wells et al., “Reaching for High-Hanging Fruit in Drug Discovery at Protein-Protein Interfaces,” Nature 450:1001-1009 (2007)). Protein interfaces are often composed of large shallow surfaces rendering them difficult targets for typical small molecule drugs (Argos, P., “An Investigation of Protein Subunit and Domain Interfaces,” Protein Eng. 2:101-113 (1988); Miller, S., “The Structure of Interfaces Between Subunits of Dimeric and Tetrameric Proteins,” Protein Eng. 3:77-83 (1989); Lo Conte et al., “The Atomic Structure of Protein-Protein Recognition Sites,” J. Mol. Biol. 285:2177-2198 (1999)). A broad effort to develop new classes of protein-protein interaction inhibitors has focused on the fundamental role played by short folded domains, or protein secondary structures, at protein interfaces (Miller, S., “The Structure of Interfaces Between Subunits of Dimeric and Tetrameric Proteins,” Protein Eng. 3:77-83 (1989)).

α-Helices constitute the largest class of protein secondary structures and mediate many protein interactions (Guharoy et al., “Secondary Structure Based Analysis and Classification of Biological Interfaces: Identification of Binding Motifs in Protein-Protein Interactions,” Bioinformatics 23:1909-1918 (2007); Jones et al., “Protein-Protein Interactions: A Review of Protein Dimer Structures,” Prog. Biophys. Mol. Bio. 63:31-65 (1995)). Helices located within the protein core are vital for the overall stability of protein tertiary structure, whereas exposed α-helices on protein surfaces constitute central bioactive regions for the recognition of numerous proteins, DNAs, and RNAs. Peptides composed of less than fifteen amino acid residues do not generally form α-helical structures at physiological conditions once excised from the protein environment; much of their ability to specifically bind their intended targets is lost because they adopt an ensemble of conformations rather than the biologically relevant one. Synthetic strategies that either stabilize short peptides (<15 residues) into α-helical conformations or mimic this domain with nonnatural scaffolds are expected to be useful models for the design of bioactive molecules and for studying aspects of protein folding (Henchey et al., “Contemporary Strategies for the Stabilization of Peptides in the Alpha-Helical Conformation,” Curr. Opin. Chem. Biol. 12:692-697 (2008); Garner et al., “Design and Synthesis of Alpha-Helical Peptides and Mimetics,” Org. BiomoL Chem. 5:3577-3585 (2007); Davis et al., “Synthetic Non-Peptide Mimetics of Alpha-Helices,” Chem. Soc. Rev. 36:326-334 (2007); Murray et al., “Targeting Protein-Protein Interactions: Lessons from 53/MDM2,” Biopolymers 88:657-686 (2007)).

Several classes of helix mimetics have been described by the synthetic organic chemistry community (Henchey et al., “Contemporary Strategies for the Stabilization of Peptides in the Alpha-Helical Conformation,” Curr. Opin. Chem. Biol. 12:692-697 (2008); Garner et al., “Design and Synthesis of Alpha-Helical Peptides and Mimetics,” Org. Biomol. Chem. 5:3577-3585 (2007); Davis et al., “Synthetic Non-Peptide Mimetics of Alpha-Helices,” Chem. Soc. Rev. 36:326-334 (2007); Murray et al., “Targeting Protein-Protein Interactions: Lessons from p53/MDM2,” Biopolymers 88:657-686 (2007)), but progress in the use of these helix mimetics in biology has been limited to a set of model protein complexes. The restricted use of these mimetics can be attributed to the lack of a systematic method for identifying helical protein interfaces that may be targeted by the various classes of stabilized helices and synthetic helix mimetics. Therefore, what is needed is a comprehensive method for identifying inter-protein interactions that serve as potential targets for the development of helical and other secondary structure mimetics.

The present invention is directed to overcoming these and other deficiencies in the art.

### SUMMARY OF THE INVENTION

A first aspect of the present invention relates to a method of generating a database of protein secondary structures that are at an interface of a two-chain inter-protein interaction. This method involves retrieving, from a protein database, multi-entity protein structures having one or more inter-chain interactions; extracting, from the retrieved multi-entity protein structures, two-chain protein structures; distinguishing the extracted two-chain protein structures having inter-protein interactions from the extracted two-chain protein structures having only intra-protein interactions; identifying the distinguished two-chain inter-protein interactions that comprise a protein secondary structure at their interface; and storing in a memory storage device the protein secondary structures at an interface of the identified two-chain inter-protein interactions.

Another aspect of the present invention relates to a computer readable medium that has stored thereon instructions that when executed by a processor generate a database of protein secondary structures that are at an interface of a two-chain inter-protein interaction. This computer readable medium has residing thereon machine executable code that when executed by at least one processor, causes the processor to perform steps that include retrieving, from a protein database, multi-entity protein structures having one or more inter-chain interactions; extracting, from the retrieved multi-entity protein structures, two-chain protein structures. The machine executable code further contains instructions in a computer programming language for distinguishing the extracted two-chain protein structures having inter-protein interactions from the extracted two-chain protein structures having only intra-protein interactions, and identifying the distinguished two-chain inter-protein interactions that comprise a protein secondary structure at their interface. The generated database of protein secondary structures that are at an interface of a two-chain inter-protein interaction are stored in a memory storage device in a format suitable for computer automated and/or manual data analysis, and/or for display/printing on a display or printing device linked to a computing system.

Another aspect of the present invention is directed to a system for generating a database of protein secondary structures that are at an interface of a two-chain inter-protein interaction. The components of this system include a retrieval module that retrieves, from a protein database stored on a memory device, multi-entity protein structures having one or more inter-chain interactions; an extraction module that extracts, from the retrieved multi-entity protein structures, two-chain protein structures; a distinguishing module that distinguishes the extracted two-chain protein structures having inter-protein interactions from the extracted two-chain protein structures having only intra-protein interactions; an identification module that identifies the distinguished two-chain inter-protein interactions that comprise a protein secondary structure at their interface; and a storage module for storing to a memory storage device the protein secondary structures at an interface of the identified two-chain inter-protein interactions. The modules/sub-modules described herein can be hardware implemented, software implemented, or an appropriate combination of both, as can be contemplated by one skilled in the art, after reading this disclosure.

Another aspect of the present invention relates to a collection of isolated protein secondary structures that are at an interface of a two-chain inter-protein interaction. This collection preferably contains about 1%, about 5%, about 10%, about 20%, about 40%, about 60%, about 80%, or about 100% of the isolated protein secondary structures of Table 2.

Another aspect of the present invention relates to a method of identifying a therapeutic drug candidate potentially effective in modulating a two-chain inter-protein interaction having a secondary structure at its interface. In one embodiment, this method involves providing a therapeutic drug candidate; selecting a protein secondary structure from a collection described herein; providing an agent that mimics the protein secondary structure; contacting the therapeutic drug candidate with the agent under conditions effective for the therapeutic drug candidate to bind to the agent; and detecting whether any binding occurs between the therapeutic drug candidate and the agent, where binding between the therapeutic drug candidate and the agent indicates that the therapeutic drug candidate is potentially effective in modulating a two-chain inter-protein interaction having the protein secondary structure at its interface.

In another embodiment, this method involves selecting a protein secondary structure from a collection of secondary structures described herein; providing a therapeutic drug candidate that mimics the protein secondary structure, and at least one protein of a two-chain inter-protein interaction having the secondary structure at its interface; contacting the therapeutic drug candidate with the at least one protein under conditions effective for the therapeutic drug candidate to bind to the at least one protein; and detecting whether any binding occurs between the therapeutic drug candidate and the at least one protein, where binding between the therapeutic drug candidate and the at least one protein indicates that the therapeutic drug candidate is potentially effective in modulating the two-chain inter-protein interaction.

### BRIEF DESCRIPTION OF THE DRAWINGS

FIGS. 1A-1B are block diagrams of a system and modules for generating a database of protein secondary structures that are at an interface of a two-chain inter-protein interaction.

FIG. 2 is a flow chart of a method of generating a database of protein secondary structures that are at an interface of a two-chain inter-protein interaction.

FIG. 3 shows an α-helix surrounded by various stabilized helices and nonnatural helix mimetics. Several of these mimetic strategies stabilize the R-helical conformation in peptides or mimic this domain with nonnatural scaffolds. These mimetic scaffolds include β-peptide helices, terphenyl helix mimetics, miniproteins, peptoid helices, side-chain crosslinked α-helices, and hydrogen-bond-surrogate (“HBS”) backbone cross-linked α-helices.

FIG. 4 is a flow chart illustrating a method of generating a database of helical secondary structures that are at an interface of a two-chain inter-protein interaction.

FIGS. 5A and 5B are pie charts showing the fraction of Protein Data Bank entries containing proteins involved in helical interfaces (FIG. 5A) and the classification of these proteins by function (FIG. 5B).

### DETAILED DESCRIPTION OF THE INVENTION

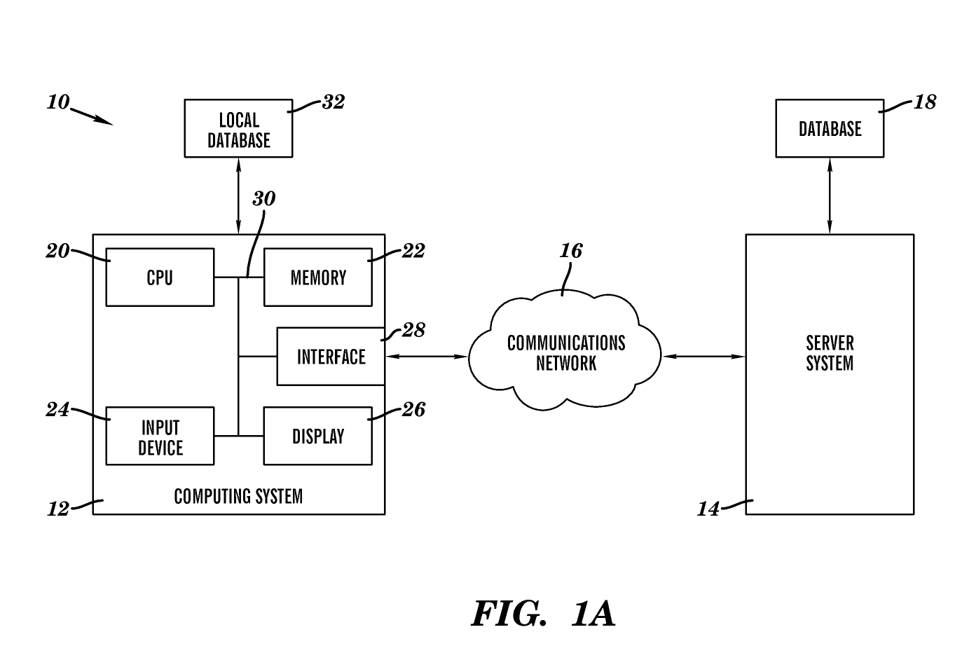

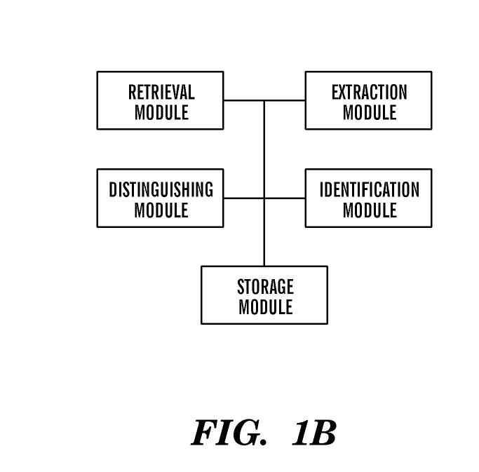

A system 10 that generates a database of protein secondary structures that are at an interface of a two-chain inter-protein interaction in accordance with other embodiments of the present invention is illustrated in FIG. 1A. The system 10 includes a computing system 12, a local database 32, a server system 14, a database 18, and a communication network 16, although the system 10 can include other types and numbers of components connected in other manners. The present invention provides a more effective method and system for generating a database of protein secondary structures that are at an interface of two-chain inter-protein interactions.

Referring more specifically to FIG. 1A, the computing system 12 is used to generate a database of protein secondary structures that are at an interface of two-chain inter-protein interactions, although other types and numbers of systems could be used, such as a server 14 (e.g., an application server), and other types and numbers of functions can be performed by the computing system 12. The computing system 12 includes a central processing unit (“CPU”) or processor 20, a memory 22, user input device 24, a display 26, and an interface system 28, and which are coupled together by a bus 30 or other link, although the computing system 12 can include other numbers and types of components, parts, devices, systems, and elements in other configurations.

The processor 20 executes a computer program or code comprising stored instructions for one or more aspects of the present invention as described and illustrated herein, although the processor could execute other numbers and types of programmed instructions. Accordingly, the computer program or code when executed by the processor performs steps for generating a database of protein secondary structures that are at an interface of a two-chain inter-protein interaction. The processor retrieves information from a database 18 connected to a remote server 14 via a communication network 16, although server 14 may not be remotely connected. According to one embodiment, the database 18 is a protein database from which multi-entity protein structures having one or more inter-chain interactions are retrieved. By executing instructions/computer program code stored, for example, in memory 22, the processor 20 extracts from the retrieved multi-entity protein structures, two-chain protein structures. The processor 20 further executes computer code that carries out the steps of distinguishing the extracted two-chain protein structures having inter-protein interactions from the extracted two-chain protein structures having only intra-protein interactions, and identifying the distinguished two-chain inter-protein interactions that comprise a protein secondary structure at their interface. From the identified two-chain inter-protein interactions that comprise a protein secondary structure at their interface, the code executed by the processor 20 extracts information pertaining to the identified interactions either for display 26 or for storage in memory 22 for later retrieval, or both, for further manipulation by a user of computing system 12, or storage in a memory storage device which is a component of the computing system 12 or a local database 32, or both.

The memory 22 stores the programmed instructions written in a computer programming language or software package for carrying out one or more aspects of the present invention as described and illustrated herein, although some or all of the programmed instructions could be stored and/or executed elsewhere. For example, instructions for executing the above-noted steps can be stored in a distributed storage environment where memory 22 is shared between one or more computing systems similar to computing system 12. A local database 32 that is separate from the computing system 12 can optionally store the programmed instructions and the identified data sets of inter-protein interactions (or other extracted information) that are identified and stored in a database using the methods and systems of the present invention. Alternatively, instead of a single computing system 12, a distributed computing system, controlled by one or more controller chips and comprising one or more computers, can also be used to execute computer program code instructions that perform various steps and methods, or control systems/modules that perform those steps of the present invention, can be contemplated by those skilled in the art, after reading this disclosure.

A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to one or more processors, can be used for the memory 22.

The user input device 24 in the computing system 12 is used to input information for a search query, although the user input device 24 could be used to input other types of data and interact with other elements. The user input device 24 can include a computer keyboard and a computer mouse, although other types and numbers of user input devices can be used.

The display 26 in the computing system 12 is used to show the extracted data or information from the identified two-chain inter-protein interactions containing a secondary structure at their interface. For example, the display can show the two-chain inter-protein interaction that contains a secondary structure at its interface, the secondary structure that is at the interface of the identified two-chain inter-protein interaction, the interface residues of the secondary protein structure at the interface of the identified two-chain inter-protein interaction, or any combination of this extracted information. The display 26 can include a computer display screen, such as a CRT or LCD screen, although other types and numbers of displays could be used.

The interface system 28 is used to operatively couple and communicate between the computing system 12, the server system 14, and the database 18 over a communication network 16, although other types and numbers of communication networks or systems with other types and numbers of connections and configurations to other types and numbers of systems, devices, and components can be used. By way of example only, the communication network 16 can use TCP/IP over Ethernet and industry-standard protocols, including SOAP, XML, LDAP, and SNMP, although other types and numbers of communication networks, such as a direct connection, a local area network, a wide area network, modems and phone lines, e-mail, optical and/or wireless communication technology, each having their own communications protocols, can be used.

The server system 14 is used to assist the computing system 10 retrieve and provide the requested data set of multi-chain inter-protein interactions although the server system 14 can perform other types and numbers of functions and the present invention can be executed in the computing system 12 without a network connection to the server system 14 or any other system. The interface system in server system 14 is used to operatively couple and communicate between the server system 14 and the computing system 12, although other types of connections and other types and combinations of systems could be used. Alternatively, server system 14 can be a distributed server or a plurality of servers each handling respective one or more electronic queries from a user of computing system 12 or an automated querying code being executed at the computing system 12.

Although embodiments of the computing system 12 and server system 14 are described and illustrated herein, the computing system and server can be implemented on any suitable computing system or computing device. It is to be understood that the devices and systems of the embodiments described herein are for exemplary purposes, as many variations of the specific hardware and software used to implement the embodiments are possible, as will be appreciated by those skilled in the relevant art(s).

Furthermore, each of the systems of the embodiments may be conveniently implemented using one or more general purpose computer systems, microprocessors, digital signal processors, and micro-controllers, programmed according to the teachings of the embodiments, as described and illustrated herein, and as will be appreciated by those of ordinary skill in the art.

In addition, two or more computing systems or devices can be substituted for any one of the systems in any embodiment of the embodiments. Accordingly, principles and advantages of distributed processing, such as redundancy and replication, also can be implemented, as desired, to increase the robustness and performance of the devices and systems of the embodiments. The embodiments may also be implemented on computer system or systems that extend across any suitable network using any suitable interface mechanisms and communications technologies, including, by way of example only, telecommunications in any suitable form (e.g., voice and modem), wireless communications media, wireless communications networks, cellular communications networks, G3 communications networks, Public Switched Telephone Networks (PSTNs), Packet Data Networks (PDNs), the Internet, intranets, and combinations thereof

The embodiments may also be embodied as a computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein. In a preferred embodiment, the computer readable code comprises a retrieval module, an extraction module, a distinguishing module, an identification module, and a storage module as shown in FIG. 1B. Computer readable medium containing these modules can be executed by one or more processors to generate a database of protein secondary structures that are at an interface of a two-chain inter-protein in interaction.

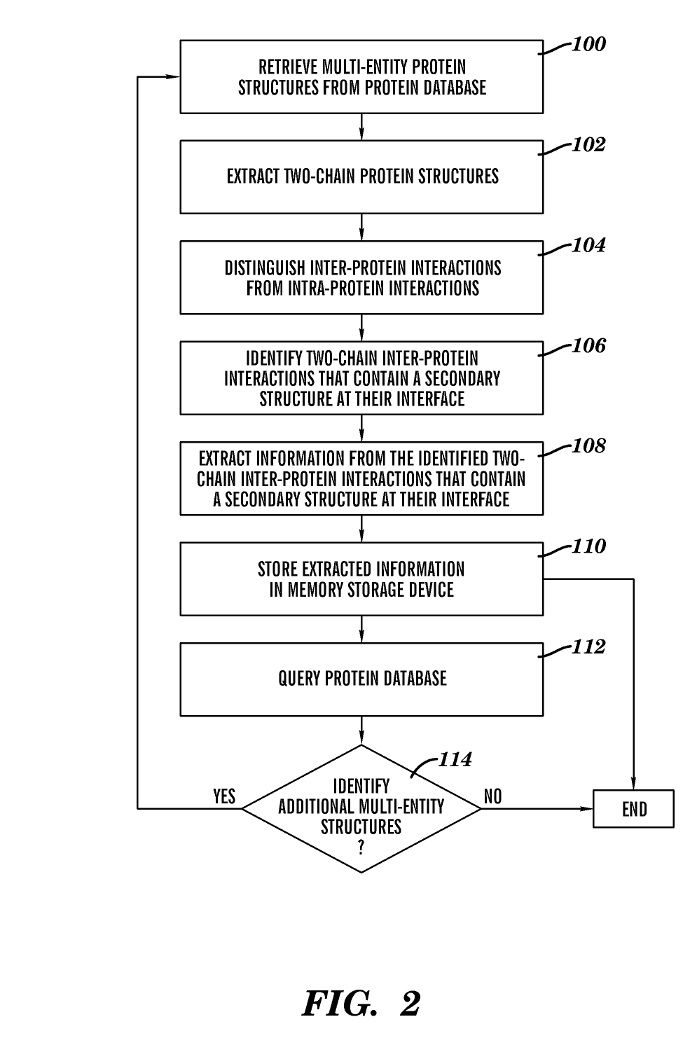

The method for generating a database of protein secondary structures that are at an interface of a two-chain inter-protein interaction in accordance with the exemplary embodiments will now be described with reference to FIG. 2. Although in this particular example, the processing steps described herein are executed by the computing system 12, some or all of these steps can be executed by other systems, devices, or components. Parts of the executable computer code can be fully automated scripts executed by CPU 20 requiring no human intervention, or alternatively can be manually executed in a step-by-step prompt manner.

In step 100, using one or more search queries, the user of computing system 12 retrieves from a protein database (connected to a remote server or connected locally to the computing system 12), multi-entity protein structures having one or more inter-chain interactions. A multi-entity protein structure encompasses any multi-protein macromolecule structure. Suitable multi-entity protein structures can be retrieved from protein databases like the Research Collaboratory for Structural Bioinformatics (“RCSB”) Protein Data Bank or the World Wide Protein Data Bank, or from other public and private databases.

In step 102, the computing system 12 executes code that extracts, from the retrieved multi-entity protein structures, two-chain protein structures. When multi-entity protein structures are retrieved from the Protein Data Bank, the format of a Protein Data Bank file allows for the retrieval of each protein chain from the file. For example, the first column of the file contains the word “ATOM” if that atom is part of a protein chain. Each chain is separated by the characters “TER”. Additionally, the fifth row of every line that begins with the “ATOM” contains the single character representing the chain. Using these three variables, the computing system 12 first identifies all chains in the Protein Data Bank file. After all chains have been identified the computing system 12 creates all possible pairs of chains. If there are n chains in the Protein Data Bank file then there will be n(n−1)/2 pairs of chains. The computing system 12 then extracts the coordinates of each pair of chains to a new file. The extracted two-chain protein structures may include both inter-protein interactions (i.e., interactions between two chains of different proteins) and intra-protein interactions (i.e., interactions between two chains of the same protein).

In step 104, the computing system 12 executes code that distinguishes the extracted two-chain protein structures having inter-protein interactions from the extracted two-chain protein structures having only intra-protein interactions. The Protein Data Bank files list the chains of each separate entity. Using the list of chains in each protein entity, the computing system 12 creates a list of possible chain pairs subject to the condition that chain pairs are not created between chains that are within the same protein entity. Any chain pairs generated from step 102 are compared to this list. Those chain pairs which appear in the list are retained and those that do not are discarded. The retained chain pairs are referred to as “inter-protein” interactions and the discarded chain pairs are referred to as “intra-protein” interactions.

In step 106, the computing system 12 executes code that identifies the distinguished two-chain inter-protein interactions that comprise a protein secondary structure at their interface. The protein secondary structure can be any secondary structure known in the art. Preferably, the protein secondary structure is a helical secondary structure, e.g., an α-helical structure. Alternatively, the protein secondary structure is a β-strand structure (also called a β-extended strand), which comprises a single continuous stretch of amino acids (e.g., 5-10 residues) that adopts an extended conformation. In another embodiment, the protein secondary structure is a β-turn structure, which comprises a short stretch of four amino acid residues in which the polypeptide chain folds back on itself by nearly 180-degrees. Methods of identifying these secondary structures are described below.

In accordance with this aspect of the present invention, identification of the distinguished two-chain inter-protein interactions that comprise a secondary structure at their interface (step 106) is achieved by linking methods of identifying protein secondary structures with methods of identifying inter-protein interaction interface amino acid residues. Although various methods of identifying protein secondary structures and methods of identifying protein interaction interface amino acid residues are available in the art, using these methods or tools individually, or even sequentially, will not identify protein secondary structures that are at an interface of an inter-chain protein interaction and the corresponding amino acid residues comprising this interface. In other words, employing a computational method for predicting a secondary structure in a two-chain inter-protein structure will identify secondary structures within the chains, but will not distinguish between secondary structures located within a protein core and secondary structures located at the interface of the inter-protein interaction. Likewise, methods of predicting amino acid residues involved in an inter-protein interaction of a two-chain protein structure will identify all interface residues without distinguishing between interface residues that are in a secondary structure and interface residues that are not in a secondary structure. The method of the present invention links these respective methods to simultaneously identify protein secondary structures at an interface and the corresponding interface amino acid residues.

The method of predicting secondary structures in step 106 can be any method known in the art. For example, as described infra, protein secondary structures can be identified by calculating the dihedral angles (φ and φ angles) of the protein backbone. Using this methodology, a helical secondary structure is identified as a protein chain segment containing at least four contiguous residues with φ and φ angles that are characteristic of an α-helix (φ=−57°±50°, φ=−47°±50°). Alternatively, a β-strand structure is identified as a protein chain segment comprising a single continuous stretch of amino acids having characteristic dihedral angles of φ=−180°±50°, φ=−180°±50°. A β-turn structure is identified as a short protein chain segment consisting of four amino acid residues (denoted by i, i+1, i+2, i+3) that fold back on themselves. There are nine classes of β-turns, each characterized by the φ and φ angles of residues i+1 and i+2 shown in Table 1.

TABLE 1
Dihedral Angles of β-Turn Structures

| Type | Phi (i + 1) | Psi (i + 1) | Phi (i + 2) | Psi (i + 2) |
|---|---|---|---|---|
| I | −60 | −30 | −90 | 0 |
| II | −60 | 120 | 80 | 0 |
| VIII | −60 | −30 | −120 | 120 |
| I′ | 60 | 30 | 90 | 0 |
| II′ | 60 | −120 | −80 | 0 |
| VIa1 | −60 | 120 | −90 | 0 |
| VIa2 | −120 | 120 | −60 | −0 |
| VIb | −135 | 135 | −75 | 160 |

| | |
|---|---|
| IV | Turns excluded from all the above categories |

A variety of other methods for identifying or predicting protein secondary structures are known in the art and are suitable for use in step 106 of the method of the present invention. These methods include identifying secondary structures based on hydrogen bonding (Baker at al., “Hydrogen Bonding in Globular Proteins,” Prog. Biophys. Mol. Biol. 44:97-179 (1984), which is hereby incorporated by reference in its entirety), hydrogen bond energy and statistically derived backbone torsion angle information (STRIDE) (Frishman et al., “Knowledge-Based Protein Secondary Structure Assignment,” Proteins: Structure, Function, and Genetics 23:566-579 (1995), which is hereby incorporated by reference in its entirety), simplified distance criteria applied to donor and acceptor separation (Fan et al., “Three-Dimensional Structure of an Fv from a Human IgM Immunoglobulin,” J. Mol. Biol. 228:188-207 (1992); Muller et al., “Structure of the Complex Between Adenylate Kinase from Escherichia coli and the Inhibitor Ap5A Refined at 1.9 Å Resolution,” J. Mol. Biol. 224:159-177 (1992), which are hereby incorporated by reference in their entirety), distance and geometric criteria (Presta et al., “Helix Signals in Proteins,” Science 240:1632-41 (1988), which is hereby incorporated by reference in its entirety), hydrogen bonding patterns in combination with main-chain dihedral angles (Benning et al., “Molecular Structure of Cytochrome c2 Isolated from Rhodobacter capsulatis Determined at 2.5 Å Resolution,” J. Mol. Biol. 220:673-685 (1991) McPhalen et al., “X-ray Structure Refinement and Comparison of Three Forms of Mitochondrial Aspartate Aminotransferase,” J. Mol. Biol. 225:495-517 (1992), which are hereby incorporated by reference in their entirety), the DSSP algorithm (Kabsch et al., “Dictionary of Protein Secondary Structure: Pattern Recognition of Hydrogen-Bonded and Geometrical Features,” Bioploymers 22:2577-2637 (1983), which is hereby incorporated by reference in its entirety), visual criteria (Other et al., “Crystallographic Refinement and Structure of DNase I at 2 Å Resolution,” J. Mol. Biol. 192:605-632 (1986), which is hereby incorporated by reference in its entirety), and a combination of several independent assignment methods (Weiss et al., “Structure of Porin Refined at 1.8 Å Resolution,” J. Mol. Biol. 227:493-509 (1992), which is hereby incorporated by reference in its entirety).

The method employed for identifying the corresponding amino acid residues of the secondary structure that are at the interface of the two-chain inter-protein interaction of step 106 can be any method known in the art. For example, as described infra, an interface amino acid residue can be identified as a residue in one protein chain of an inter-protein interaction having at least one atom within a 5 Å radius of an atom in the other protein chain of the two-chain inter-protein interaction (Ofran et al., “Analysing Six Types of Protein Interfaces,” J. Mol. Biol. 325:377-0387 (2003); Kortemme et al., “Computational Alanine Scanning of Protein-Protein Interfaces,” Sci. STKE 2004(219):12 (2004), which are hereby incorporated by reference in their entirety). Alternatively an interface amino acid residue is identified as a result of it becoming significantly buried upon interaction with residues of another protein. Accordingly, measuring the density of C_{β} atoms surrounding a C_{β} atom of an amino acid residue in one chain of an identified two-chain inter-protein interaction can identify interface amino acid residues (Ofran et al., “Analysing Six Types of Protein Interfaces,” J. Mol. Biol. 325:377-0387 (2003); Kortemme et al., “Computational Alanine Scanning of Protein-Protein Interfaces,” Sci. STKE 2004(219):12 (2004), which are hereby incorporated by reference in their entirety).

An alternative method for identifying interface amino acid residues that is also suitable for use in step 106 of the claimed method involves calculating the solvent accessible surface area (“SASA”) (Jones et al., “Principles of Protein-Protein Interactions,” Proc. Natl Acad. Sci. USA 93:13-20 (1996), which is hereby incorporated by reference in its entirety). Various algorithms for calculating SASA are known in the art, each defining an interface residue based on its change in solvent accessible surface area when transitioning from an unbound state to a bound state.

Some two-chain inter-protein interactions may be present in more than one database (e.g., PDB) entry. Following identification of the two-chain inter-protein interactions that contain a secondary structure at their interface in step 106, it may be desirable to remove any redundant interactions from the identified two-chain inter-protein interactions before extracting and storing information regarding the identified interactions. As described herein, redundant interactions (i.e., structures having greater than 95% sequence similarity) can be searched and removed using the CD-HIT algorithm (Li et al., “Clustering of Highly Homologous Sequences to Reduce the Size of Large Protein Databases,” Bioinformatics 17:282-283 (2001), which is hereby incorporated by reference in its entirety). Other sequence alignment programs known in the art are also suitable for removing redundant interactions. The CD-HIT algorithm searches the sequence information of each chain of an interaction from the PDB FASTA file. To ensure that only redundant two-chain interactions are removed (rather than redundant single chains), it is preferable to remove the chain identifier from the FASTA file before executing the CD-HIT algorithm search, so that the entire amino acid sequence of the protein-protein complex is searched rather than just the individual protein chains.

In step 108 the user computer executes code that extracts information from the identified two-chain inter-protein interactions that contain a secondary structure at their interface. This extracted information can be stored and/or displayed in any format suitable for the user viewing the information. The extracted information may contain a list of the two-chain inter-protein interactions that contain a secondary structure at their interface. In another embodiment, the extracted information may show the secondary structures that are at the interface of a two-chain inter-protein interaction. In another embodiment, the extracted information may name the interface residues within the protein secondary structures at the interface of a two-chain inter-protein interaction. The user computer can extract any of the above information alone or in combination. Suitable examples of extracted information include the information shown in Tables 2, 6, and 17 herein.

In step 110, the extracted information is stored in a memory storage device. The stored extracted information can be readily retrieved by a user and used for any desired application. For example, as described below, the extracted information can be used to further identify hot-spot amino acid residues within the identified interface residues of a two-chain inter-protein interaction containing a secondary structure at its interface. Optionally, the extracted information can be forwarded to other computer systems and/or databases external to computing system 12 for further processing.

In step 112, the database of secondary structures that are at an interface of a two-chain inter-protein interaction can be updated periodically by querying the protein database at various time intervals to identify one or more additional multi-entity protein structures. Such updating can be manual or automated. Once a new multi-entity structure is identified (step 114), it is retrieved, two-chain protein structures are extracted, two-chain protein structures containing inter-protein interactions are distinguished from two-chain protein structures containing only intra-protein interactions, and two-chain inter-protein interactions that have a protein secondary structure at their interface are identified and stored/displayed. Information (e.g., the function and/or identity of the proteins involved in the two-chain inter-protein interactions, the secondary structures present at their interface, and/or the interface residues within the secondary structure) concerning the newly-identified two-chain inter-protein interactions is compared to the information present in the existing database to identify non-redundant information. Any non-redundant information can be added to the database by storing it in the memory storage device, or any of the databases shown in FIG. 1A.

The present method identifies, e.g., interface amino acid residues within a protein secondary structure at the interface of a two-chain inter-protein interaction. In a preferred embodiment of the present invention, the “hot spot” amino acid residues among the identified interface residues are also identified. As used herein, “hot spot” amino acid residues refers to those interface amino acid residues that are important mediators of the two-chain inter-protein binding interaction. More specifically, hot spot residues are the interface residues that contribute significantly to the binding free energy of the protein-protein complex. Hot spot residues and their corresponding binding sites can be identified, for example, using amino acid mutation or substitution technique. In a preferred embodiment, hot spot residues are identified using alanine mutagenesis techniques. Following substitution of an individual interface residue with an alanine residue, the free energy of the protein complex is computed. Hot-spot residues are identified as those residues in which alanine substitution has a destabilizing effect on the free energy of binding (ΔΔG_{bind}) of more than 1 kcal/mol (Bogan et al., “Anatomy of Hot Spots in Protein Interfaces,” J. Mol. Biol. 280(1):1-9 (1998); Keskin et al., “Principles of Protein-Protein Interactions: What Are the Preferred Ways for Proteins to Interact?” Chem. Rev. 108(4): 1225-44 (2008), which are hereby incorporated by reference in their entirety).

Alanine mutagenesis can be carried out using experimental or theoretical approaches. Experimental approaches include systematic alanine mutagenesis of the identified interface residues by generating and purifying individual mutant proteins for analysis. However, because this is a time-consuming and laborious procedure, it is preferable to use an alternative, high through-put method such as a combinatorial library of alanine substitution or the method of “shotgun scanning.” Shotgun scanning implements a simplified format for combinatorial alanine scanning and utilizes phage-display libraries of alanine-substituted proteins for analysis (Morrison et al., “Combinatorial Alanine-Scanning,” Curr. Opin. Chem. Biol. 5:302-07 (2001), which is hereby incorporated by reference in its entirety). An alternative experimental approach suitable for use in the method of the present invention is covalent tethering, which is a process involving the use of equilibrium disulfide exchange to target potential binding partners within a specific region of the interface and calculate relative binding affinities (DeLano W., “Unraveling Hot Spots in Binding Interfaces: Progress and Challenges,” Curr. Opin. Struct. Biol. 12:14-20 (2002), which is hereby incorporated by reference in its entirety).

In addition to the experimental approaches for determining hot spot amino acids through alanine mutagenesis, predictive computational approaches have been developed that reproduce the experimental values with less time, effort, and expense. A number of algorithms and methods have been developed to accurately calculate the binding free energies of known three-dimensional structures and the effect of mutations on these affinities. Suitable methods include empirical knowledge-based (statistical) scoring approaches in conjunction with simple physical models (Moreira et al., “Computational Determination of the Relative Free Energy of Binding—Application to Alanine Scanning Mutagenesis in Molecular Material with Specific Interactions,” in MODELING AND DESIGN (Andrezej W. Sokalski ed., 2007), which is hereby incorporated by reference in its entirety), atomistic simulations including both the rigorous free energy perturbation and thermodynamic integration (Kollman P A, “Free Energy Calculations—Applications to Chemical and Biochemical Phenomena,” Chem. Rev. 93:2395-2417 (1993); Gouda et al., “Free Energy Calculations for Theophylline Binding to an RNA Aptamer: Comparison of MM-PBSA and Thermodynamic Integration Methods,” Biopolymers 68:16-34 (2002), which are hereby incorporated by reference in their entirety), protein cleft analysis combined with physical properties (Burgoyne et al., “Predicting Protein Interaction Sites: Binding Hot-Spots in Protein-Protein and Protein-Ligand Interfaces,” Bioinformatics 22(11):1335-1342 (2006), which is hereby incorporated by reference in its entirety). More approximate methods of identifying interface hot spot residues include MM-PBSA (Kollman et al., “Calculating Structures and Free Energies of Complex Molecules: Combining Molecular Mechanics and Continuum Models,” Acc. Chem. Res. 33:889-897 (2000), which is hereby incorporated by reference in its entirety), λ-dynamics (Kong et al., “Lambda Dynamics—A New Approach to Free Energy Calculations,” J. Chem. Phys. 105:2414-2423 (1996); Moreira et al., “Accuracy of the Numerical Solution of the Poisson-Boltzmann Equation,” J. Mol. Struct. 729:11-18 (2005); Moreira et al., “Hot Spots Computational Identification—Application to the Complex Formed Between the Hen Egg-White Lysozyme (HEL) and the Antibody HyHEL-10,” Int. J. Quantum Chem. 107:299-310 (2006), which are hereby incorporated by reference in their entirety), chemical Monte-Carlo/molecular mechanics (Moreira et al., “Accuracy of the Numerical Solution of the Poisson-Boltzmann Equation,” J. Mol. Struct. 729:11-18 (2005), which is hereby incorporated by reference in its entirety), and ligand interaction scanning (Moreira et al., “Hot Spots Computational Identification—Application to the Complex Formed Between the Hen Egg-White Lysozyme (HEL) and the Antibody HyHEL-10,” Int. J. Quantum Chem. 107:299-310 (2006), which is hereby incorporated by reference in its entirety).

The identity of interface hot spot residues can also be determined using other experimental approaches, including molecular biology based methods such as the yeast two-hybrid system, ubiquitin-based split-protein sensor, and Fluorescence Resonance Energy transfer; mass spectrometry methods; and protein microarrays.

In another embodiment of the present invention, the protein secondary structures at an interface of a two-chain inter-protein interaction are classified by the biological function(s) of the proteins involved in the respective interaction. This classification identifies new potential protein targets useful for targeted drug development and screening.

Another aspect of the present invention relates to a collection of isolated protein secondary structures that are at an interface of a two-chain inter-protein interaction, where the collection contains about 1%, about 5%, about 10%, about 20%, about 40%, about 60%, about 80%, or about 100% of the isolated protein secondary structures of Table 2. The representative collection of secondary structures at an interface of two-chain inter-protein interactions listed in Table 2 below was identified using the methods of the present invention. Redundant interactions have been removed from this collection to generate a non-redundant collection of two-chain inter-protein interactions having a secondary structure at their interface. In accordance with this aspect of the invention, the collection is a collection of helical protein secondary structures.

This collection of the present invention preferably contains m through n secondary structures, where m and n are integers and n is greater than m. Preferably, m is 2, 4, 8, 10, 50, 100, 200, 300, 400, 500, 600, 700, 800, 900, 1000, 1500, 2000, 2500, 3000, 3500, 4000, 4500, or 5000; and n is 10, 15, 50, 100, 200, 300, 400, 500, 600, 700, 800, 900, 1000, 1500, 2000, 2500, 3000, 3500, 4000, 4500, 5000, 5500, 6000, 6500, 7000, 7500, 8000, 8500, 9000, or 10000.

Lengthy table referenced here
US20100281003A1-20101104-T00001
Please refer to the end of the specification for access instructions.

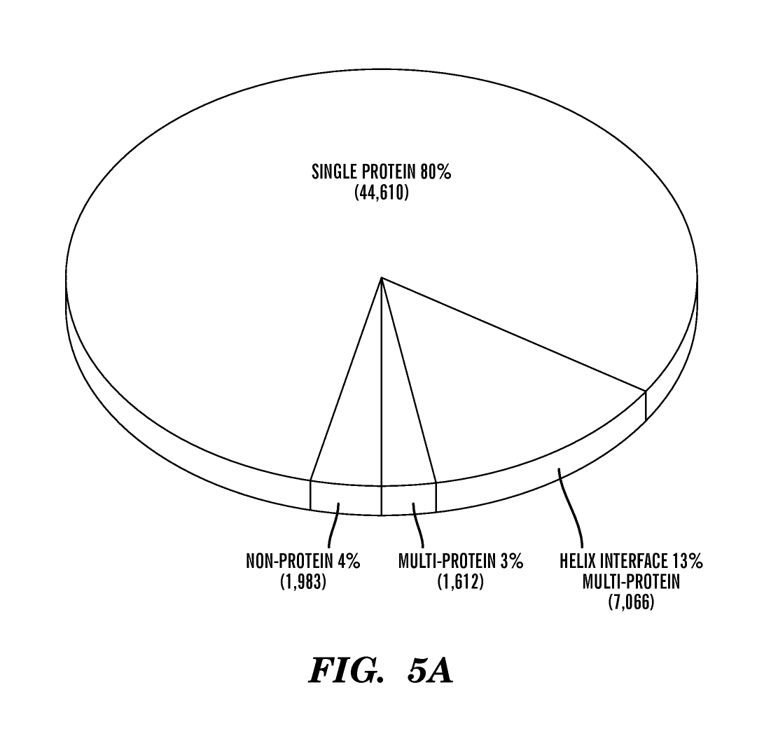

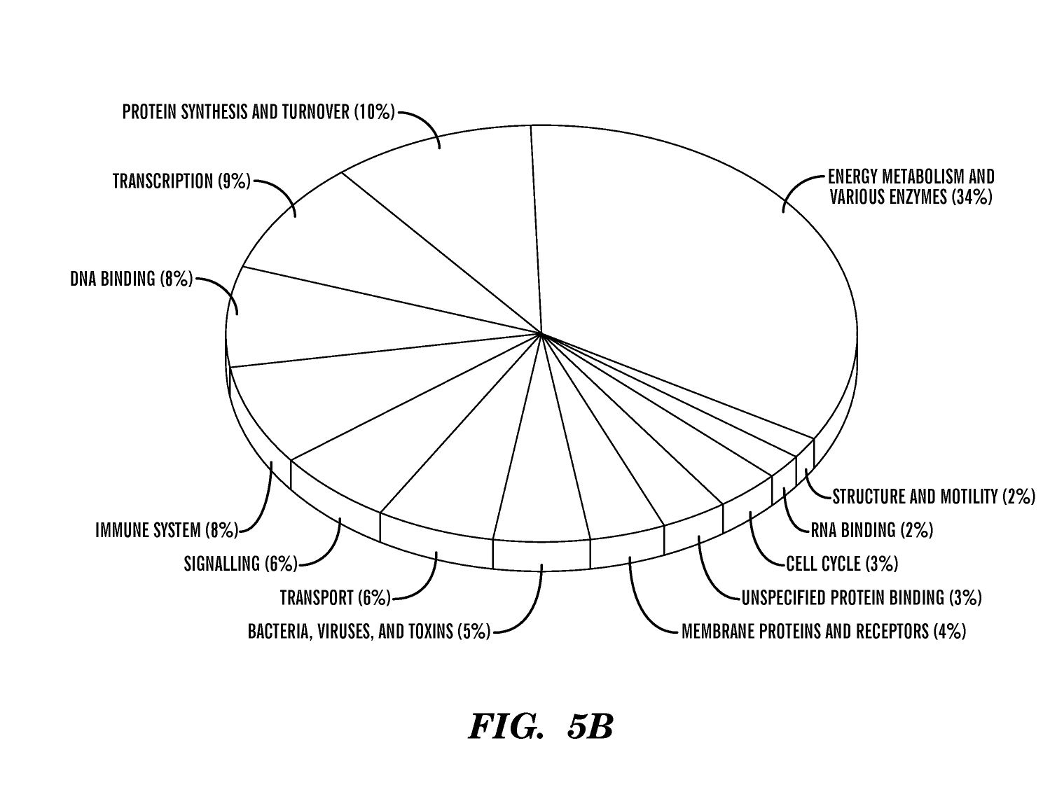

As described supra, the collection of protein secondary structures that are at an interface of a two-chain inter-protein interaction can be classified by the biological function of the interacting proteins. These sub-collections of secondary structures at an interface of a two-chain inter-protein interaction provide targeted collections for identifying interactions that are suitable targets for therapeutic drug design and screening purposes. As shown in FIG. 5, the representative collection of secondary structures at an interface of a two-chain inter-protein interaction identified using the methods described herein can be classified into several functional categories.

In one embodiment of the present invention, the collection is a collection of protein secondary structures potentially involved in modulating the cell cycle. Table 3 below is a list of PDB entries taken from Table 2 that contain secondary structures at the interface of a two-chain inter-protein interaction that are potentially involved in modulating cell cycle. A preferred collection according to the present embodiment contains about 1%, about 5%, about 10%, about 20%, about 40%, about 60%, about 80%, or about 100% of the protein secondary structures that are present in the PDB entries identified in Table 3.

TABLE 3
Representative HIPP Interactions Involved in Cell Cycle

| CLASSIFICATION | PDB CODE |
|---|---|
| APOPTOSIS | 1D2Z, 1F3V, 1F9E, 1G5J, 1I3O, 1NW9, 1PQ1, 1TY4, |
| | 1ZY3, 2A5Y, 2G5B, 2JBY, 2JM6, 2K7W, 2NLA, 2OF5, |
| | 2P1L, 2PQK, 2PQN, 2PQR, 2ROC, 2ROD, 2V6Q, |
| | 2VOF, 2VOG, 2VOH, 2VOI, 2ZNE, 3D7V, 3EZQ, |
| | 3FDL, 3H11, 3I1H, 3YGS, 3EB6 |
| APOPTOSIS INHIBITOR/APOPTOSIS | 2K6Q, 1G73, 2PON |
| APOPTOSIS/HYDROLASE | 1I4O, 1KMC, 2FUN, 3F2O |
| CELL CYCLE | 1DOA, 1F47, 1GO4, 1I2M, 1N2D, 1N4M, 1OTR, 1R4M, |
| | 1SA0, 1XEW, 2AFF, 2CCI, 2DFK, 2DOQ, 2GGM, |
| | 2GV5, 2I3S, 2I3T, 2K2I, 2OBH, 2QYF, 2RAW, 2RAX, |
| | 2V4Z, 2VE7, 2W96, 3DAB, 3DAC, 3DBH, 3EAB, |
| | 3EUH, 3EUK, 3FDO, 3G03, 3G33, 3G65, 3GGR, 1KAT, |
| | 3C0R, 1G3N, 2AZE, 3FWB, 3FWC, 1IBR, 2ZXX, |
| | 1JOW, 1N4M |
| CELL CYCLE PROTEIN | 1M45, 1M46 |
| CELL CYCLE, STRUCTURAL PROTEIN | 2QAG |
| CELL CYCLE/CELL CYCLE/CELL CYCLE | 2QFA |
| CELL CYCLE/TRANSPORT PROTEIN | 3E1R |
| COMPLEX (CYTOKINE/RECEPTOR) | 1EER |
| COMPLEX (ONCOGENE PROTEIN/PEPTIDE) | 1YCR |
| KINASE/KINASE ACTIVATOR | 1H4L |
| LIGASE, CELL CYCLE | 2AST |
| TRANSFERASE/CELL CYCLE | 1OL5, 1WMH |
| OTHER | 1YCS, 1BXL, 1AON |

In another embodiment of the present invention, the collection is a collection of protein secondary structures potentially involved in modulating DNA binding. Table 4 below is a list of PDB entries taken from Table 2 that contain secondary structures at the interface of a two-chain inter-protein interaction that are potentially involved in modulating DNA binding. These two-chain inter-protein interactions include proteins that target DNA but are not involved in transcription. A preferred collection according to the present embodiment contains about 1%, about 5%, about 10%, about 20%, about 40%, about 60%, about 80%, or about 100% of the protein secondary structures that are present in the PDB entries identified in Table 4.

TABLE 4
Representative HIPP Interactions Involved in DNA Binding

| CLASSIFICATION | PDB CODE |
|---|---|
| DNA BINDING PROTEIN | 1L1O, 1N1J, 1OSV, 1T0F, 1UB4, 1UHL, 1XV9, 2A1J, |
| | 2BKY, 2HUE, 2NTI, 2O97, 3BQO, 3BU8, 3BUA, 3EI4, |
| | 3FPN, 1QUQ, 1VYJ, 2BYK |
| DNA BINDING PROTEIN, CHAPERONE | 3BTP |
| DNA BINDING PROTEIN/DNA | 1AKH, 1AOI, 1JEY, 1PH1, 2O8F, 2QSH, 3EI2 |
| DNA BINDING PROTEIN/RECOMBINATION/ | 1P4E |
| DNA | |
| DNA BINDING PROTEIN/TRANSFERASE | 1DML |
| HYDROLASE/DNA | 2D7D, 2PJR |
| ISOMERASE/DNA | 2B9S, 3FOE |
| LEUCINE ZIPPER | 1A93 |
| RECOMBINATION | 2V1C |
| REPLICATION | 1F2U, 1II8, 1P9D, 1SXJ, 1TUE, 1U7B, 2E9X, 2EHO, |
| | 2HII, 2HIK, 2IX2, 2PQA, 2Q9Q, 2R6C |
| REPLICATION, TRANSFERASE | 1ZT2 |
| REPLICATION, DNA BINDING PROTEIN | 2PI2, 1YYP |
| REPLICATION/DNA | 2QBY |
| REPLICATION/TRANSFERASE | 1ZT2, 1YYP |
| STRUCTURAL PROTEIN/DNA | 1EQZ, 1F66, 1ID3, 1KX4, 1U35, 1ZBB, 2F8N, 2FJ7, |
| | 2I0Q, 2NQB, 2NZD, 3C1B |
| TRANSCRIPTION, TRANSFERASE/DNA-RNA | 3ERC, 3GTM, 3HOU, 3HOY |
| HYBRID | |
| TRANSFERASE/DNA | 1RTD, 3GLI |
| TRANSFERASE/ELECTRON TRANSPORT/DNA | 1SKR |
| OTHER | 1AXC, 1BI4, 1JB7, 2VTB, 1H6K, 2ZYZ |

In another embodiment of the present invention, the collection is a collection of protein secondary structures potentially involved in modulating energy metabolism or enzymatic activity. Table 5 below is a list of PDB entries taken from Table 2 that contain secondary structures at the interface of a two-chain inter-protein interaction that are potentially involved in modulating energy metabolism or enzymatic activity. These two-chain inter-protein interactions include hydrolases, oxidoreductases, and transferases, among other enzymes. A preferred collection according to the present embodiment contains about 1%, about 5%, about 10%, about 20%, about 40%, about 60%, about 80%, or about 100% of the protein secondary structures that are present in the PDB entries identified in Table 5.

TABLE 5
Representative HIPP Interactions Involved in Energy Metabolism or Enzymatic Activity

| CLASSIFICATION | PDB CODE |
|---|---|
| ASPARTYL PROTEASE | 1LYW, 1AVF |
| ATP SYNTHASE | 1SKY |
| COMPLEX (METALLOPROTEASE/ | 1SMP, 1UEA |
| INHIBITOR) | |
| COMPLEX (PROTEASE/INHIBITOR) | 1HIA |
| COMPLEX (PROTEINASE/INHIBITOR) | 2SNI, 1SBN |
| COMPLEX (SERINE | 1A0H, 1AZZ, 1BCR, 1BTH, 1CA0, 1CBW, 1TBQ, 1CHO, 1CSE, |
| PROTEASE/INHIBITOR) | 1MEE, 1TEC, 4SGB |
| COMPLEX (TRANSFERASE/PEPTIDE) | 1A81 |
| DEHYDROGENASE | 1H0H |
| DIOXYGENASE | 1B4U |
| ELECTRON TRANSPORT | 1O96, 1BGY, 1EFP, 1EYS, 1KN1, 1O94, 1PHN, 1Z8U, 2AXT, |
| | 2C7J, 2JBL, 2JXM, 2PUK, 2PVG, 2PVO, 2QJK, 2QJP, 2UUN, |
| | 3A0B, 3BZ1, 1JJU, 3A0B, 3BZ1 |
| ELECTRON | 1FCD |
| TRANSPORT(FLAVOCYTOCHROME) | |
| GLYCOSIDASE | 2AAI |
| GLYCOSIDASE/CARBOHYDRATE | 1ABR |
| GLYCOSYLASE | 1UGH |
| HYDROGENASE | 1E08, 13DE |
| HYDROLASE | 1AOK, 1APY, 1AYY, 1B5F, 1CLV, 1CP9, 1E1H, 1E9Y, 1EJR, |
| | 1EUV, 1EZQ, 1FFU, 1FLC, 1FS0, 1FWA, 1FX0, 1FXW, 1G0U, |
| | 1GK0, 1HR8, 1HWM, 1ICF, 1ID5, 1IRU, 1IXR, 1IXS, 1JBU, 1JD2, |
| | 1JTG, 1K3B, 1KFU, 1KLI, 1N8O, 1N9G, 1NB3, 1NBF, 1NBW, |
| | 1NFU, 1NX0, 1OOK, 1OQS, 1OR0, 1OWS, 1OYV, 1P0S, 1PC8, |
| | 1Q5Q, 1Q5R, 1Q7L, 1QHH, 1R6O, 1RZO, 1S70, 1SCJ, 1SP4, |
| | 1T3M, 1V02, 1VZJ, 1W0Y, 1W1I, 1WPX, 1WYW, 1X3Z, 1XD3, |
| | 1XM4, 1XZP, 1Y75, 1YBQ, 1YM0, 1YU6, 1Z00, 2A1D, 2A7U, |
| | 2ADV, 2AYO, 2BFZ, 2BGN, 2BO9, 2BR2, 2C4F, 2CLY, 2CMY, |
| | 2CZV, 2D07, 2DD4, 2DFX, 2DOI, 2DXB, 2ES4, 2F43, 2F4O, |
| | 2FHH, 2GD4, 2GEZ, 2GJX, 2H4C, 2HD5, 2HLD, 2IAE, 2IBI, |
| | 2IOF, 2IUC, 2IZO, 2J0Q, 2J0S, 2J0T, 2J0U, 2J59, 2J5G, 2J7Q, |
| | 2J88, 2JE6, 2JEA, 2JET, 2JIZ, 2NGR, 2NP0, 2NYL, 2P2C, 2P3F, |
| | 2P9V, 2PV9, 2QE7, 2QKL, 2QKM, 2QL5, 2QOG, 2QY0, 2RD4, |
| | 2V7Q, 2VBL, 2VBN, 2VBO, 2VOY, 2VSK, 2WAX, 2WG8, 2WHP, |
| | 2WJV, 2Z2Y, 2ZAE, 2ZAL, 2ZCY, 2ZIV, 2ZIX, 2ZLE, 2ZU6, |
| | 3BGO, 3BN9, 3C5W, 3C91, 3D7W, 3DF0, 3DW8, 3E6P, 3EDQ, |
| | 3EDX, 3ESW, 3F6Z, 3F75, 3FKS, 3FSG, 3G9K, 3H4P, 3HKI, |
| | 3HKJ, 3I3T, 3UBP, 1AYY, 1IRU, 2HLD, 2VOY, 2ZCY, 2ZLE, |
| | 3C91 |
| HYDROLASE (SERINE PROTEASE) | 1EPT |
| HYDROLASE (SERINE PROTEINASE) | 1HLE, 1HRT, 1HPP |
| HYDROLASE ACTIVATOR | 1FNT, 1YA7, 1Z7Q, 2IY0 |
| HYDROLASE INHIBITOR/HYDROLASE | 1CQ4, 2H4P, 2H4Q, 3F02, 9PAI, 1TA3, 2NQD, 3F1S, 1B27, 1DP5, |
| | 1DPJ, 1DTD, 1EZX, 1F34, 1I51, 1IBX, 1LQM, 1SR5, 1WMI, |
| | 1XG2, 1Z7X, 1ZLH, 1ZLI, 2ABZ, 2D26, 2E2D, 2G2U, 2GKV, |
| | 2O3B, 2OUL, 2ZHX, 3B9F, 3BG4, 3BOW, 3CBJ, 3D4U, 3E2K, |
| | 1JIW |
| HYDROLASE(O-GLYCOSYL) | 1NCA |
| HYDROLASE/HYDROLASE ACTIVATOR | 1FNT, 1YA7, 1Z7Q, 2IY0 |
| HYDROLASE/HYDROLASE INHIBITOR | 1TA3, 2NQD, 3F1S, 1B27, 1DP5, 1DPJ, 1DTD, 1EZX, 1F34, 1I51, |
| | 1IBX, 1LQM, 1SR5, 1WMI, 1XG2, 1Z7X, 1ZLH, 1ZLI, 2ABZ, |
| | 2D26, 2E2D, 2G2U, 2GKV, 2O3B, 2OUL, 2ZHX, 3B9F, 3BG4, |
| | 3BOW, 3CBJ, 3D4U, 3E2K, 1JIW |
| HYDROLASE/HYDROLASE | |
| INHIBITOR/DNA | |
| HYDROLASE/INHIBITOR | 1EJM, 1GPQ, 1JTD, 1OC0, 1UDI, 1UUZ, 2BEX, 2J8X, 2O8A, |
| | 2VU8 |
| HYDROLASE/LIGASE | 2GWF |
| HYDROLASE/PROTEIN BINDING | 1NU7, 1NU9, 1V5I, 1ZNV, 2G4D, 2PT7, 1UPT |
| HYDROLASE/TRANSFERASE | 1FQ1, 2NN6, 3D6N |
| HYDROLASE/UNKNOWN FUNCTION | 3ENO |
| ISOMERASE | 1CB7, 1E1C, 1W2W, 1XRS, 2HP0, 2PV2, 2ZBK, 3FDZ |
| LIGASE | 1C4Z, 1EUC, 1FBV, 1FQV, 1FS1, 1FS2, 1FXT, 1JW9, 1LDK, |
| | 1U6G, 1UR6, 1Y8R, 1Y8X, 1Z56, 1Z5S, 2AKW, 2C4O, 2DF4, 2E |
| | 32, 2EJF, 2F9Y, 2GRN, 2NU9, 2O25, 2OOB, 2OXQ, 2RHS, 2VJE, |
| | 3D54, 3DQV, 3E 95, 3EQS, 3FN1, 3FSH, 3H0L |
| LIGHT HARVESTING COMPLEX | 1LGH, 1CPCP, 1LIA, 1ALL |
| LUMINESCENCE | 2G2S, 2GW4 |
| LYASE | 1AHJ, 1BXN, 1DIO, 1GXS, 1I1Q, 1I7M, 1I7Q, 1IBT, 1IR2, 1IRE, |
| | 1IWA, 1IWP, 1LVC, 1MHM, 1MT1, 1NBU, 1NZY, 1P7T, 1PYU, |
| | 1QDL, 1RCO, 1S0Y, 1SVD, 1UHE, 1UZD, 1UZH, 1V29, 1WDD, |
| | 1WDW, 1YSL, 1ZQ1, 2AL2, 2DPP, 2FYM, 2QCD, 2QQD, 2UZ1, |
| | 2VLH, 3DTV, 3ET6, 3GZD |
| LYASE (CARBON-CARBON) | 1RLD, 4RUB |
| LYASE, OXIDOREDUCTASE/TRANSFERASE | 1WDK |
| LYASE/OXIDOREDUCTASE | 1NVM |
| LYASE/TRANSFERASE | 2ISS |
| METHANOGENESIS | 1HBM |
| MOLYBDENUM-IRON PROTEIN | 1MIO |
| MONOOXYGENASE | 1MTY |
| OXIDOREDUCTASE | 1BCC, 1BIQ, 1BVY, 1CC1, 1DGH, 1DII, 1E6E, 1E6V, 1E6Y, |
| | 1E7P, 1EO2, 1EP3, 1F6M, 1FFT, 1FIQ, 1FYZ, 1G20, 1G72, 1G8K, |
| | 1GX7, 1H1L, 1H2A, 1H2R, 1H4J, 1JK0, 1JK9, 1JMX, 1JNR, 1JRO, |
| | 1JZD, 1KF6, 1KFY, 1KQF, 1LRW, 1M1Y, 1M56, 1MG2, 1MHY, |
| | 1MJG, 1N5W, 1NHG, 1NI4, 1NTK, 1OAO, 1OIJ, 1Q16, 1R1R, |
| | 1R27, 1RM6, 1SB3, 1SQB, 1SQX, 1T0Q, 1T3Q, 1TI2, 1ULI, |
| | 1UM9, 1USP, 1V54, 1VRQ, 1VRS, 1WQL, 1WYU, 1XLT, 1XME, |
| | 1Y56, 1YE9, 1YKK, 1YQ3, 1ZOY, 1ZY8, 2AFH, 2BMO, 2BP7, |
| | 2BRU, 2BS4, 2CKF, 2D0V, 2DE5, 2E1M, 2EQ7, 2EQ9, 2FBW, |
| | 2FOI, 2FRV, 2FUG, 2FYN, 2GAG, 2GBW, 2H9A, 2HT9, 2IBZ, |
| | 2IFQ, 2INN, 2INP, 2IVF, 2J55, 2J57, 2J7A, 2JGD, 2K9F, 2O8V, |
| | 2PKQ, 2QJY, 2R00, 2UW1, 2V1S, 2V3B, 2V4J, 2VDC, 2VL2, |
| | 2VR0, 2VRC, 2VVL, 2VYN, 2WD7, 2WD7, 2WME, 3B9J, 3BLW, |
| | 3BMC, 3C75, 3C7B, 3CF4, 3CWB, 3CXH, 3DHH, 3DMT, 3DTU, |
| | 3E7S, 3E9J, 3EH3, 3EN1, 3ETR, 3EUB, 3EXG, 3EXH, 3FGC, |
| | 3GE8, 3HRD, 1G20, 2P80, 1ZRT |
| OXIDOREDUCTASE COMPLEX | 2RII |
| OXIDOREDUCTASE, TRANSFERASE | 3DUF, 1J31 |
| OXIDOREDUCTASE/BIOSYNTHETIC | 1Z5Y, 2FHS |
| PROTEIN | |
| OXIDOREDUCTASE/ELECTRON | 1KYO, 1NEK, 2A1T, 2ACZ, 2YVJ, 2ZON, 1T9G, 2GC4, 2A1T |
| TRANSPORT | |
| OXIDOREDUCTASE/PROTEIN BINDING | 2F5Z |
| OXIDOREDUCTASE/TRANSCRIPTION | 2UXN |
| REGULATOR | |
| PHOSPHOTRANSFERASE | 1GLA, 1KI6 |
| PHOTOSYNTHESIS | 1B33, 1B8D, 1EYX, 1F99, 1GH0, 1I7Y, 1IJD, 1IZL, 1JB0, 1K6L, |
| | 1L9B, 1L9J, 1Q90, 1QGW, 1S5L, IVF5, 1W5C, 2BV8, 2E 74, 2JIY, |
| | 2JJ0, 2O01, 2VJH, 2VJT, 2VML, 2ZT9, 3DBJ |
| POLYMERASE | 2C35 |
| PROTEIN BINDING/TRANSFERASE | 2A78, 2OV2 |
| SERINE PROTEASE | 1DY8, 2HNT |
| SERINE PROTEINASE | 1DX5 |
| TRANSERASE, TOXIN | 1S5E |
| TRANSFERASE | 1BUH, 1CF4, 1D8D, 1DCE, 1F3M, 1F51, 1F5Q, 1F80, 1FM0, |
| | 1GO3, 1H5R, 1IW7, 1JQJ, 1JR3, 1KA9, 1MU2, 1N4Q, 1N8Z, |
| | 1N95, 1O2F, 1OW7, 1P16, 1POI, 1Q95, 1S78, 1TN6, 1TQY, 1U54, |
| | 1VRA, 1VYW, 1W98, 1XPK, 1XXH, 1XXI, 1Y14, 1YNJ, 1Z7M, |
| | 1ZUN, 2A3I, 2B8K, 2B9I, 2BE7, 2BE9, 2BOV, 2BTW, 2C52, |
| | 2DBU, 2DRN, 2EG4, 2F49, 2F9I, 2FEW, 2FHJ, 2FTK, 2GHO, |
| | 2GOO, 2HHF, 2HWN, 2HY5, 2HYB, 2I2X, 2IDO, 2IFG, 2J0M, |
| | 2JGZ, 2NNW, 2NPT, 2O2V, 2ONL, 2OQ1, 2PA8, 2QIE, 2QM6, |
| | 2QR1, 2R5C, 2RF4, 2RF9, 2V1Y, 2V36, 2V4I, 2V55, 2V5Q, 2V8Q, |
| | 2VDU, 2VDW, 2VGO, 2VJM, 2WEL, 3A1G, 3BWN, 3C66, 3C72, |
| | 3CDK, 3CR3, 3D7U, 3DRA, 3E0J, 3E8C, 3EZB, 3FDS, 3FHI, |
| | 3FLO, 3GLH, 3GM1, 3GTU, 3H1C, 3HGK, 3HKZ, 3HPG, 1IW7, |
| | 1LTX, 1HVU |
| TRANSFERASE/HYDROLASE | 2BCJ, 2CG5 |
| OTHER | 1OE9, 1BXR, 1AJS, 1BJO, 1NWD, 2BCX, 1CDL, 1PON, 1SY9, |
| | 2BBM, 1CFF, 1CKK, 1CKN, 2PCF, 1AY7, 1DHK, 1TOC, 1TCO, |
| | 1IBC, 1A4Y, 1AVZ, 1BGX, 1YCP, 1SPB, 1JSU, 1DAN, 1AW8, |
| | 2HZE, 1QFN, 3CFA, 1BPL, 2QAR, 2QB0, 1MF8, 2FHX, 1M63, |
| | 1ONK, 1F96, 2GMI, 2K2Q, 3C14, 1XFU, 1XFV, 1GPW, 2NV2, |
| | 1RYP, 1NDO, 1HMV, 1OCC, 1MMO, 2V1D, 5CSC, 1HBH, 1PRC, |
| | 1PSS, 1FPP, 1PMA, 2PE6, 2QHO, 1EGP, 2BKR, 1E 44, 1CAX |

A sub-collection of the collection of protein secondary structures potentially involved in modulating enzymatic activity is a collection of protein secondary structures at the interface of two-chain inter-protein interactions that include kinases. A representative collection of secondary structures that are at an interface of a two-chain inter-protein interaction that includes a kinase is shown in Table 6 below. The specific amino acid interface residues comprising the helical structures at the interface of the two-chain inter-protein interaction are also shown in Table 6. These, along with other helical structures at an interface of a kinase, are also included in Table 2.

TABLE 6
Interface Residues of the Secondary Structure
Inter-Protein Interaction for Representative Kinases

| PDB CODE | PARTNER | CHAIN | NUMBER | RESIDUES | SEQ ID NO: |
|---|---|---|---|---|---|
| 1BLX | B | A | 104 to 112 | DLTTYLDKV | 22206 |
| 1BLX | A | B | 5 to 19 | VCVGDRLSGAR | 22207 |
| 1BLX | A | B | 44 to 48 | TALNV | 22208 |
| 1BLX | A | B | 76 to 84 | SPVHDAART | 22209 |
| 1KDX | B | A | 597 to 611 | QDLRSHLVHKLVQAI | 22210 |
| 1KDX | B | A | 646 to 664 | RDEYYHLLAEKIYKIQKEL | 22211 |
| 1KDX | A | B | 119 to 131 | TDSQKRREILSRR | 22212 |
| 1KDX | A | B | 134 to 145 | YRKILNDLSSDA | 22213 |
| 1OW6 | D | A | 1011 to 1046 | VIDSLQQEYKKQMLTAHALAVDAKN | 22214 |
| | | | | LLDQARLKM | |
| 1OW6 | A | D | 2 to 13 | TRELDELMASLS | 22215 |
| 1OW6 | F | C | 949 to 975 | EYVPMVKEVGLALRTLATVDETIPLP | 22216 |
| 1OW6 | F | C | 981 to 1007 | REIEMAQKLLNSDLGELINKMKLAQQY | 22217 |
| 1OW6 | C | F | 2 to 12 | TRELDELMASL | 22218 |
| 1WMH | B | A | 73 to 88 | SQLELEEAFRLYE | 22219 |
| 1WMH | A | B | 38 to 51 | GFQEFSRLLRAVHQIPG | 22220 |
| 1YJ5 | C | B | 227 to 242 | PAEVFKGKVEAVLEKL | 22221 |
| 2A19 | A | B | 489 to 500 | FETSKFFTDLRD | 22222 |
| 2CH4 | W | A | 497 to 501 | VSEVS | 22223 |
| 2CH4 | A | W | 507 to 517 | MDVVKNVVESL | 22224 |
| 2CH4 | B | Y | 140 to 145 | KIIEEI | 22225 |
| 2EHB | D | A | 33 to 46 | EEVEALYELFKLS | 22226 |
| 2EHB | D | A | 58 to 65 | EEFQLALF | 22227 |
| 2EHB | D | A | 74 to 83 | FADRIFDVFD | 22228 |
| 2EHB | D | A | 93 to 102 | GEFVRSLGVF | 22229 |
| 2EHB | D | A | 109 to 120 | HEKVKFAFKLYD | 22230 |
| 2EHB | D | A | 130 to 143 | EELKEMVALHES | 22231 |
| 2EHB | D | A | 150 to 164 | DMIEVMVDKAFVQAD | 22232 |
| 2EHB | D | A | 174 to 183 | DEWKDFVSLN | 22233 |
| 2EHB | A | D | 311 to 318 | NAFEMITL | 22234 |
| 2GIT | F | D | 57 to 84 | PEYWEGETRKVKAHSQTHARV | 22235 |
| | | | | DLGTLRGY | |
| 2GIT | F | D | 138 to 149 | MAQTTKHKWEA | 22236 |
| 2GIT | F | D | 152 to 160 | VAEQLRAYL | 22237 |
| 2GIT | F | D | 162 to 174 | GTCVEWLRRYLEN | 22238 |
| 2NPT | D | A | 74 to 95 | SDEEMKAMLSYYSTVMEQQVN | 22239 |
| 2NPT | B | C | 75 to 95 | DEEMKAMLSYYSTVMEQQVN | 22240 |

In another embodiment of the present invention, the collection is a collection of protein secondary structures potentially involved in modulating immune system function. Table 7 below is a list of PDB entries taken from Table 2 that contain secondary structures at the interface of a two-chain inter-protein interaction that are potentially involved in modulating immune system function. A preferred collection according to the present embodiment contains about 1%, about 5%, about 10%, about 20%, about 40%, about 60%, about 80%, or about 100% of the protein secondary structures that are present in the PDB entries identified in Table 7.

TABLE 7
Representative HIPP Interactions Involved in Immune Function

| CLASSIFICATION | PDB CODE |
|---|---|
| ANTIBIOTIC/IMMUNE SYSTEM | 1XKM |
| ANTIBODY | 1BFO, 1CE1, 1HEZ, 1UWE, 1GHF, 1JTO |
| ANTITUMOR PROTEIN | 1JM7, 1GH6, 1T2V |
| BLOOD CLOTTING | 1I5K, 1J9C, 1JMO, 1JOU, 1JY2, 1LQ8, 1LWU, 1M1J, |
| | 1N73, 1N86, 1SDD, 1SQ0, 1U0N, 1XMN, 2A45, |
| | 2B5T, 2FFD, 2HOD, 2PUQ, 2VVC, 3BVH, 3GHG, |
| | 3H32, 2ODY, 2ADF |
| CATALYTIC ANTIBODY | 15C8, 1KEL, 1YED |
| CIRCADIAN CLOCK PROTEIN | 1SUY, 1U9I |
| COAGULATION FACTOR | 1RFN, 1IXX, 1E0F |
| COMPLEX (ANTIBODY/PEPTIDE) | 1SM3, 2HIP |
| COMPLEX (IMMUNOGLOBULIN/LIPOPROTEIN) | 1OS0 |
| COMPLEX | 1NFD |
| (IMMUNORECEPTOR/IMMUNOGLOBULIN) | |
| COMPLEX (OXIDOREDUCTASE/ANTIBODY) | 1AR1 |
| COMPLEX(ANTIBODY-ANTIGEN) | 1BJ1, 1FBI, 1FCC, 2JEL, 1JHL, 3HFM |
| HISTOCOMPATIBILITY ANTIGEN I-AK | 1IAK |
| HYDROLASE, BLOOD CLOTTING, TOXIN | 2E3X |
| HYDROLASE, BLOOD CLOTTING | 2H9E, 3ENS |
| HYDROLASE/IMMUNE SYSTEM | 1T6V, 1ZV5, 1ZVY, 3D9A, 3G3A, 3G3B, 3H42 |
| IMMUNE SYSTEM | 1OQD, 1BM3, 1BX2, 1BZ7, 1C12, 1C5B, 1C5D, |
| | 1CL7, 1CT8, 1CU4, 1CZ8, 1D9K, 1DEE, 1DN0, |
| | 1DQQ, 1DZB, 1ED3, 1EFX, 1EJO, 1ETZ, 1F11, 1F3D, |
| | 1F3J, 1F4W, 1F90, 1FE8, 1FG9, 1FH5, 1FJ1, 1FL5, |
| | 1FN4, 1FNS, 1FSK, 1FYH, 1G0Y, 1H0T, 1HDM, |
| | 1HQ4, 1HQR, 1HYR, 1I1A, 1I3R, 1I7Z, 1IL1, 1IM9, |
| | 1J8H, 1JGL, 1JGV, 1JL4, 1JNH, 1JNL, 1JPS, 1K8I, |
| | 1KC5, 1KCG, 1KCS, IKFA, 1KJ2, 1KN2, 1KTD, |
| | 1KTK, 1L0X, 1L7T, 1LK3, 1LO0, 1LO4, 1LP1, 1LP9, |
| | 1LQS, 1MEX, 1MHP, 1MI5, 1MUJ, 1MVF, 1MWA, |
| | 1N0X, 1NAK, 1NC2, 1ND0, 1NGW, 1NJ9, 1NL0, |
| | 1OEY, 1OQO, 1P4B, 1PG7, 1PZ5, 1Q1J, 1Q72, 1Q9O, |
| | 1Q9W, 1R24, 1RHH, 1RIH, 1RJL, 1RZ7, 1RZF, 1RZG, |
| | 1RZI, 1S3K, 1S9V, 1SEQ, 1T4K, 1T66, 1TZH, 1TZI, |
| | 1U3H, 1UM4, 1UWX, 1UYW, 1W72, 1XCQ, 1XCT, |
| | 1XGP, 1YMM, 1YNK, 1YNT, 1YPZ, 1YY8, 1Z92, |
| | 1ZA6, 1ZAN, 1ZGL, 2A9M, 2AAB, 2ADG, 2AGJ, |
| | 2AI0, 2AJ3, 2AJZ, 2AK4, 2AP2, 2AQ1, 2ARJ, 2BC4, |
| | 2BDN, 2BRR, 2CMR, 2D03, 2DQT, 2E7L, 2EH8, |
| | 2ESV, 2F54, 2FJF, 2FL5, 2FX8, 2G2R, 2G60, 2G75, |
| | 2G9H, 2GJZ, 2GSI, 2HFG, 2HH0, 2HWZ, 2I26, 2I26, |
| | 2IAM, 2IAN, 2ICE, 2ICW, 2IPK, 2IPU, 2J5L, 2NNA, |
| | 2NOJ, 2NTF, 2NX5, 2O5X, 2OI9, 2OJZ, 2OQJ, 2OSL, |
| | 2P24, 2PXY, 2Q6W, 2Q86, 2Q8A, 2QEJ, 2QKI, 2QR0, |
| | 2RD7, 2UYL, 2V17, 2V7H, 2V7N, 2VL5, 2VLJ, |
| | 2VLR, 2VOL, 2VQ1, 2VWE, 2VXU, 2VXV, 2VYR, |
| | 2W65, 2W80, 2W9E, 2WBJ, 2WII, 2WIN, 2Z4Q, |
| | 2Z7X, 2Z8V, 2Z91, 2ZCK, 2ZPK, 32C2, 3BKJ, 3BKY, |
| | 3BQU, 3BT2, 3BZ4, 3C8K, 3CDG, 3CFB, 3CFD, |
| | 3CFK, 3CLE, 3CMO, 3CUP, 3CVH, 3D0L, 3D5O, |
| | 3D69, 3DGG, 3DIF, 3DVG, 3DXA, 3E3Q, 3E8U, |
| | 3EFD, 3EYF, 3EYQ, 3FFC, 3G04, 3G6A, 3G6D, 3G6J, |
| | 3GIZ, 3GJF, 3HAE, 3HC0, 3HE6, 3HE7, 3HG1, 3HNS, |
| | 3HRZ, 3HS0, 3HUJ, 3I2C, 7CEI, 1UVQ, 3GKW, |
| | 2FD6, 2FHZ, 2FSE, 3H0T, 2H9G, 1IQD, 1UJ3, 1Z3G, |
| | 3EOA, 1V7N, 2ERJ, 3D85, 3DUH, 3EO1, 1CBV, |
| | 1KEG, 2FR4, 3FFD, 3F8U, 1HH9, 1YJD, 1ZA3, |
| | 1HXY, 1LO5, 3ETB, 3B2U, 3GKW, 2FD6, 2FHZ, |
| | 2FSE, 1D9K, 1I3R, 1ZGL, 2GJ7, 2VXQ, 2JTT, 1TH1, |
| | 3FCS, 3FCU, 2GOX, 1XL3, 1IGC, 1WEJ, 1FPT, |
| | 1FDL, 2VIR, 1BVK, 1IAI, 1A2Y, 1NSN, 1MPA, |
| | 2HRP, 1AHW, 2SEB, 1SEB, 1AQD, 1AO7, 1BD2, |
| | 1UCY, 1ACY, 1KXV, 3EIQ, 1RIW, 1TB6, 1IAO, |
| | 1SBS, 1QLE, 1J34, 1QO3, 1QO3, 1OVA, 2Q97, 1FRT, |
| | 1UCY |
| IMMUNE SYSTEM RECEPTOR | 2BNQ |
| IMMUNE SYSTEM, HYDROLASE | 1C08, 1H0D, 1RI8, 1RJC, 2DQF, 2ZNW, 3EBA |
| IMMUNE SYSTEM/VIRAL PROTEIN | 2DD8, 2I9L, 2QHR, 3CSY, 1GHQ, 2GJ7 |
| IMMUNOGLOBULIN | 1A3L, 1A4J, 1A6T, 1AD0, 1AD9, 1AE6, 1AJ7, 1AXT, |
| | 1BAF, 1CIC, 1CLO, 1CLY, 1DBA, 1DFB, 1FAI, |
| | 1FOR, 1GGI, 1IBG, 1IGF, 1IGT, 1IND, 1MCP, 1MFB, |
| | 1MIM, 1NLD, 1PLG, 1PSK, 1TET, 1VGE, 1YUH, |
| | 2FBJ, 2FGW, 2GFB, 2PCP, 7FAB, 12E8 |
| ISOMERASE | 1CB7, 1E1C, 1W2W, 1XRS, 2HP0, 2PV2, 2ZBK, |
| | 3FDZ |
| ISOMERASE/IMMUNE SYSTEM | 3F8U |
| TOXIN/IMMUNE SYSTEM | 2NTS |
| TRANSFERASE/ANTIBODY/DNA | 1T03 |
| TRANSFERASE/IMMUNE SYSTEM/DNA | 3GRW |

In another embodiment of the present invention, the collection is a collection of protein secondary structures potentially involved in modulating cell membrane proteins or receptor interactions. Table 8 below is a list of PDB entries taken from Table 2 that contain secondary structures at the interface of a two-chain inter-protein interaction that are potentially involved in modulating cell membrane proteins or receptor interactions. A preferred collection according to the present embodiment contains about 1%, about 5%, about 10%, about 20%, about 40%, about 60%, about 80%, or about 100% of the protein secondary structures that are present in the PDB entries identified in Table 8.

TABLE 8
Representative HIPP Interactions of Membrane Proteins and Receptors

| CLASSIFICATION | PDB CODE |
|---|---|
| CELL RECEPTOR | 2CDE, 2CDF, 2CDG |
| LECTIN | 1LEN, 1LOC, 1LOF, 2B7Y |
| LIPID BINDING PROTEIN | 2PO6 |
| MEMBRANE PROTEIN | 1C17, 1EF1, 1H2S, 1K4C, 1KIL, 1ORQ, 1ORS, 1QD6, |
| | 1R3I, 1RPQ, 2A0L, 2A79, 2BE6, 2EXW, 2F93, 2F95, |
| | 2H8P, 2J8S, 2K9J, 2NZ0, 2ONK, 2QAC, 2QI9, 2VT1, |
| | 3B5N, 3C4M, 3C5J, 3CHX, 3DVE, 3EFF, 3EHU, 1Q68, |
| | 2RMK, 2FKW, 3BXK, 3CSL |
| MEMBRANE PROTEIN, IMMUNE SYSTEM, | 2F2L |
| TOXIN | |
| MEMBRANE PROTEIN, PROTEIN TRANSPORT | 3BZL, 3C01, 3C03, 3DIN, 2R9R |
| MEMBRANE PROTEIN, TRANSFERASE | 2FFF |
| MEMBRANE PROTEIN, PROTEIN BINDING | 2ODG, 1P8D |
| MEMBRANE PROTEIN/CHAPERON | 1XKP |
| MEMBRANE PROTEIN/HYDROLASE | 1P8V, 3DHW |
| MEMBRANE PROTEIN/MEMBRANE | 3DIN |
| TRANSPORT | |
| OXIDOREDUCTASE, MEMBRANE PROTEIN | 1YEW |
| OXYGEN BINDING | 2R1H, 2RAO |
| PROTEIN BINDING/PROTEIN TRANSPORT | 1VF6, 1VG0, 1VG9 |
| RECEPTOR | 2BYP, 2UZ6 |
| RECEPTOR/GLYCOPROTEIN | 2V5P |
| SUGAR BINDING PROTEIN | 1GGP, 1LNU, 1PUM, 3C5Z, 3C60, 3C6L, 1NMU |
| OTHER | 2PRG, 1A6A, 2SIV, 1GZL, 2IY1, 2J9D, 1RSO, 2HLF, |
| | 2FYL |

In another embodiment of the present invention, the collection is a collection of protein secondary structures potentially involved in modulating other protein binding or have an unknown function. Table 9 below is a list of PDB entries taken from Table 2 that contain secondary structures at the interface of a two-chain inter-protein interaction that are potentially involved in modulating other protein binding or have an unknown function. A preferred collection according to the present embodiment contains about 1%, about 5%, about 10%, about 20%, about 40%, about 60%, about 80%, or about 100% of the protein secondary structures that are present in the PDB entries identified in Table 9.

TABLE 9
Representative HIPP Interactions Involved in Other Protein Binding or Unknown Function

| CLASSIFICATION | PDB CODE |
|---|---|
| BINDING PROTEIN | 1QO0 |
| BIOSYNTHETIC PROTEIN | 1TO9, 1TYG, 2HTM, 2Z2L, 2ZC5, 1RF8, 2ZU0, 1ZM2 |
| COMPLEX (BLOOD COAGULATION/PEPTIDE) | 1MKW |
| COMPLEX | 1EBD |
| (OXIDOREDUCTASE/TRANSFERASE) | |
| COMPLEX (PEPTIDE BINDING | 1X11 |
| MODULE/PEPTIDE) | |
| DE NOVO PROTEIN | 1KD8, 1KDD, 1XOF, 1ZSZ, 1BB1, 2OTK, 1SVX |
| IMMUNE SYSTEM | 1OQD, 1BM3, 1BX2, 1BZ7, 1C12, 1C5B, 1C5D, 1CL7, |
| | 1CT8, 1CU4, 1CZ8, 1D9K, 1DEE, 1DN0, 1DQQ, |
| | 1DZB, 1ED3, 1EFX, 1EJO, 1ETZ, 1F11, 1F3D, 1F3J, |
| | 1F4W, 1F90, 1FE8, 1FG9, 1FH5, 1FJ1, 1FL5, 1FN4, |
| | 1FNS, 1FSK, 1FYH, 1G0Y, 1H0T, 1HDM, 1HQ4, |
| | 1HQR, 1HYR, 1I1A, 1I3R, 1I7Z, 1IL1, 1IM9, 1J8H, |
| | 1JGL, 1JGV, 1JL4, 1JNH, 1JNL, 1JPS, 1K8I, 1KC5, |
| | 1KCG, 1KCS, 1KFA, 1KJ2, 1KN2, 1KTD, 1KTK, |
| | 1L0X, 1L7T, 1LK3, 1LO0, 1LO4, 1LP1, 1LP9, 1LQS, |
| | 1MEX, 1MHP, 1MI5, 1MUJ, 1MVF, 1MWA, 1N0X, |
| | 1NAK, 1NC2, 1ND0, 1NGW, 1NJ9, 1NL0, 1OEY, |
| | 1OQO, 1P4B, 1PG7, 1PZ5, 1Q1J, 1Q72, 1Q9O, 1Q9W, |
| | 1R24, 1RHH, 1RIH, 1RJL, 1RZ7, 1RZF, 1RZG, 1RZI, |
| | 1S3K, 1S9V, 1SEQ, 1T4K, 1T66, 1TZH, 1TZI, 1U3H, |
| | 1UM4, 1UWX, 1UYW, 1W72, 1XCQ, 1XCT, 1XGP, |
| | 1YMM, 1YNK, 1YNT, 1YPZ, 1YY8, 1Z92, 1ZA6, |
| | 1ZAN, 1ZGL, 2A9M, 2AAB, 2ADG, 2AGJ, 2AI0, |
| | 2AJ3, 2AJZ, 2AK4, 2AP2, 2AQ1, 2ARJ, 2BC4, 2BDN, |
| | 2BRR, 2CMR, 2D03, 2DQT, 2E7L, 2EH8, 2ESV, 2F54, |
| | 2FJF, 2FL5, 2FX8, 2G2R, 2G60, 2G75, 2G9H, 2GJZ, |
| | 2GSI, 2HFG, 2HH0, 2HWZ, 2I26, 2I26, 2IAM, 2IAN, |
| | 2ICE, 2ICW, 2IPK, 2IPU, 2J5L, 2NNA, 2NOJ, 2NTF, |
| | 2NX5, 2O5X, 2OI9, 2OJZ, 2OQJ, 2OSL, 2P24, 2PXY, |
| | 2Q6W, 2Q86, 2Q8A, 2QEJ, 2QKI, 2QR0, 2RD7, 2UYL, |
| | 2V17, 2V7H, 2V7N, 2VL5, 2VLJ, 2VLR, 2VOL, 2VQ1, |
| | 2VWE, 2VXU, 2VXV, 2VYR, 2W65, 2W80, 2W9E, |
| | 2WBJ, 2WII, 2WIN, 2Z4Q, 2Z7X, 2Z8V, 2Z91, 2ZCK, |
| | 2ZPK, 32C2, 3BKJ, 3BKY, 3BQU, 3BT2, 3BZ4, 3C8K, |
| | 3CDG, 3CFB, 3CFD, 3CFK, 3CLE, 3CMO, 3CUP, |
| | 3CVH, 3D0L, 3D5O, 3D69, 3DGG, 3DIF, 3DVG, |
| | 3DXA, 3E3Q, 3E8U, 3EFD, 3EYF, 3EYQ, 3FFC, 3G04, |
| | 3G6A, 3G6D, 3G6J, 3GIZ, 3GJF, 3HAE, 3HC0, 3HE6, |
| | 3HE7, 3HG1, 3HNS, 3HRZ, 3HS0, 3HUJ, 3I2C, 7CEI, |
| | 1UVQ, 3GKW, 2FD6, 2FHZ, 2FSE, 3H0T, 2H9G, |
| | 1IQD, 1UJ3, 1Z3G, 3EOA, 1V7N, 2ERJ, 3D85, 3DUH, |
| | 3EO1, 1CBV, 1KEG, 2FR4, 3FFD, 3F8U, 1HH9, 1YJD, |
| | 1ZA3, 1HXY, 1LO5, 3ETB, 3B2U, 3GKW, 2FD6, |
| | 2FHZ, 2FSE, 1D9K, 1I3R, 1ZGL, 2GJ7, 2VXQ, 2JTT, |
| | 1TH1, 3FCS, 3FCU, 2GOX, 1XL3, 1IGC, 1WEJ, 1FPT, |
| | 1FDL, 2VIR, 1BVK, 1IAI, 1A2Y, 1NSN, 1MPA, 2HRP, |
| | 1AHW, 2SEB, 1SEB, 1AQD, 1AO7, 1BD2, 1UCY, |
| | 1ACY, 1KXV, 3EIQ, 1RIW, 1TB6, 1IAO, 1SBS, 1QLE, |
| | 1J34, 1QO3, 1QO3, 1OVA, 2Q97, 1FRT, 1UCY |
| METAL BINDING PROTEIN | 1MXE, 1PSB, 1XK4, 1Z6O, 2HQW, 2K2F, 2O60, |
| | 2OGX, 2ZFB, 3G43, 2H61, 2H0D, 1QS7, 1IQ5, 1IWQ, |
| | 2JU0, 1YR5, 1ZUZ, 2BEC, 2E 30, 2FOT, 2JJZ, 2W73 |
| PEPTIDE BINDING PROTEIN | 2IHS |
| PLANT PROTEIN | 1DGR, 1DGW, 2DS2, 2Q3N |
| PROTEIN BINDING | 1IZN, 1L0O, 1OQP, 1X2T, 1YFN, 1ZL8, 1ZW3, 2ASQ, |
| | 2B87, 2DEN, 2DZN, 2FYZ, 2HYE, 2I94, 2IJ0, 2K3S, |
| | 2K8B, 2O98, 2ODB, 2R1T, 2VDB, 2ZL1, 3B71, 3CK4, |
| | 3CRP, 3DA7, 3DXC, 3F1I, 3GMW, 1ZL8 |
| TRANSFERASE/PROTEIN BINDING | 1LTX, 2QLV |
| UNKNOWN FUNCTION | 1J7D, 1TPX, 2UVP, 2UYN, 2VH3, 3FXD, 2JND, 1QLS, |
| | 3PRO, 2V8F, 3MON |

In another embodiment of the present invention, the collection is a collection of protein secondary structures potentially involved in modulating protein synthesis or turnover. Table 10 below is a list of PDB entries taken from Table 2 that contain secondary structures at the interface of a two-chain inter-protein interaction that are potentially involved in modulating protein synthesis or turnover. These two-chain inter-protein interactions include chaperone proteins, proteosomes, ribosomes, and the like. A preferred collection according to the present embodiment contains about 1%, about 5%, about 10%, about 20%, about 40%, about 60%, about 80%, or about 100% of the protein secondary structures that are present in the PDB entries identified in Table 10.

TABLE 10
Representative HIPP Interactions Involved in Protein Folding and Turnover

| CLASSIFICATION | PDB CODE |
|---|---|
| CHAPERONE | 1DKD, 1FXK, 1HT1, 1JYO, 1L2W, 1LZW, 1PCQ, |
| | 1TTW, 1USV, 1WE3, 1XQS, 2C2V, 2CG9, 2D0O, 2JKI, |
| | 2K5B, 2UWJ, 2VGX, 2ZDI, 3CQX, 3D2E, 3GZ1 |
| CHAPERONE, PROTEIN TRANSPORT | 2GUZ |
| CHAPERONE, STRUCTURAL, MEMBRANE | 3BUW, 1ZE3 |
| PROTEIN | |
| CHAPERONE/CELL INVASION | 2FM8 |
| COMPLEX (HSP24/HSP70) | 1DKG |
| COMPLEX OF TWO ELONGATION FACTORS | 1EFU, 1AIP |
| HISTONE/CHAPERONE | 3CFV |
| HYDROLASE/TRANSLATION | 2VSO |
| PROTEASOME ACTIVATOR | 1AVO |
| PROTEIN SYNTHESIS/TRANSFERASE | 2A19 |
| PROTEIN TURNOVER/PROTEIN TURNOVER | 2DYM |
| RIBOSOME | 1CE7, 1DD4, 1G1X, 1HR0, 1I94, 1IBL, 1JJ2, 1KQS, |
| | 1N34, 1PNS, 1Q86, 1QVF, 1S1H, 1T0K, 1VOQ, 1VQN, |
| | 1VQP, 1VS5, 1VS6, 1VSA, 1VSP, 1W2B, 1XMQ, |
| | 1YL3, 1YL4, 2B9M, 2D3O, 2E5L, 2GY9, 2GYA, 2HGI, |
| | 2HGJ, 2HGP, 2HGR, 2HHH, 2I2P, 2I2T, 2J01, 2J03, |
| | 2J28, 2J37, 2OM7, 2OTJ, 2QA4, 2QBE, 2QEX, 2QOU, |
| | 2QOW, 2QOY, 2QP0, 2V46, 2VHM, 2VHN, 2VHO, |
| | 2WDI, 2WH1, 2WH2, 2WH4, 2ZJQ, 3BBN, 3BBO, |
| | 3BO0, 3CMA, 3D5A, 3D5B, 3D5D, 3DEG, 3F1E, 3F1F, |
| | 3FIC, 3FIH, 3FIK, 3FIN, 3G4S |
| RIBOSOME INHIBITOR | 3DD7 |
| RIBOSOME INHIBITOR, HYDROLASE | IJCH |
| STRUCTURAL PROTEIN/CHAPERONE | 1XOU |
| TRANSFERASE/RIBOSOMAL PROTEIN | 3CJS, 3CJT |
| TRANSLATION | 1EJH, 1F60, 1RK8, 1RY1, 1XB2, 2D1P, 2D74, 2GID, |
| | 2HDN, 2JGB, 2QMU, 2V8W, 3CW2, 3E1Y |
| TRANSLATION/IMMUNE SYSTEM | 1SYX |
| TRANSLATION/RNA | 2GJE, 2GO5 |
| OTHER | 2GGP, 3C7N, 1HX1, 1G3I, 1G4B, 1YYF, 2Z5C, 2JSS, |
| | 2PQ4, 2IO5, 2NVU, 2FIF, 2PMZ, 1WKW |

In another embodiment of the present invention, the collection is a collection of protein secondary structures potentially involved in modulating RNA binding. Table 11 below is a list of PDB entries taken from Table 2 that contain secondary structures at the interface of a two-chain inter-protein interaction that are potentially involved in modulating RNA binding. A preferred collection according to the present embodiment contains about 1%, about 5%, about 10%, about 20%, about 40%, about 60%, about 80%, or about 100% of the protein secondary structures that are present in the PDB entries identified in Table 11.

TABLE 11
Representative HIPP Interactions Involved in RNA Binding

| CLASSIFICATION | PDB CODE |
|---|---|
| HYDROLASE | 1AOK, 1APY, 1AYY, 1B5F, 1CLV, 1CP9, 1E1H, 1E9Y, 1EJR, |
| | 1EUV, 1EZQ, 1FFU, 1FLC, 1FS0, 1FWA, 1FX0, 1FXW, 1G0U, |
| | 1GK0, 1HR8, 1HWM, 1ICF, 1ID5, 1IRU, 1IXR, 1IXS, 1JBU, |
| | 1JD2, 1JTG, 1K3B, 1KFU, 1KLI, 1N8O, 1N9G, 1NB3, 1NBF, |
| | 1NBW, 1NFU, 1NX0, 1OOK, 1OQS, 1OR0, 1OWS, 1OYV, |
| | 1P0S, 1PC8, 1Q5Q, 1Q5R, 1Q7L, 1QHH, 1R6O, 1RZO, 1S70, |
| | 1SCJ, 1SP4, 1T3M, 1V02, 1VZJ, 1W0Y, 1W1I, 1WPX, 1WYW, |
| | 1X3Z, 1XD3, 1XM4, 1XZP, 1Y75, 1YBQ, 1YM0, 1YU6, 1Z00, |
| | 2A1D, 2A7U, 2ADV, 2AYO, 2BFZ, 2BGN, 2BO9, 2BR2, |
| | 2C4F, 2CLY, 2CMY, 2CZV, 2D07, 2DD4, 2DFX, 2DOI, |
| | 2DXB, 2ES4, 2F43, 2F4O, 2FHH, 2GD4, 2GEZ, 2GJX, 2H4C, |
| | 2HD5, 2HLD, 2IAE, 2IBI, 2IOF, 2IUC, 2IZO, 2J0Q, 2J0S, |
| | 2J0T, 2J0U, 2J59, 2J5G, 2J7Q, 2J88, 2JE6, 2JEA, 2JET, 2JIZ, |
| | 2NGR, 2NP0, 2NYL, 2P2C, 2P3F, 2P9V, 2PV9, 2QE7, 2QKL, |
| | 2QKM, 2QL5, 2QOG, 2QY0, 2RD4, 2V7Q, 2VBL, 2VBN, |
| | 2VBO, 2VOY, 2VSK, 2WAX, 2WG8, 2WHP, 2WJV, 2Z2Y, |
| | 2ZAE, 2ZAL, 2ZCY, 2ZIV, 2ZIX, 2ZLE, 2ZU6, 3BGO, 3BN9, |
| | 3C5W, 3C91, 3D7W, 3DF0, 3DW8, 3E6P, 3EDQ, 3EDX, |
| | 3ESW, 3F6Z, 3F75, 3FKS, 3FSG, 3G9K, 3H4P, 3HKI, 3HKJ, |
| | 3I3T, 3UBP, 1AYY, 1IRU, 2HLD, 2VOY, 2ZCY, 2ZLE, 3C91 |
| HYDROLASE/RNA | 3DD2 |
| HYDROLASE/RNA BINDING | 2HYI, 3EX7 |
| PROTEIN/RNA | |
| ISOMERASE/BIOSYNTHETIC | 2HVY, 3HAX, 3HAY, 2EY4 |
| PROTEIN/RNA | |
| ISOMERASE/RNA | 2RFK, 3HJW, 3HJY |
| LIGASE/RNA | 1EIY |
| LIGASE/RNA BINDING PROTEIN | 2HRK, 2HSN |
| RIBOSOME | 1CE7, 1DD4, 1G1X, 1HR0, 1I94, 1IBL, 1JJ2, 1KQS, 1N34, |
| | 1PNS, 1Q86, 1QVF, 1S1H, 1T0K, 1VOQ, 1VQN, 1VQP, 1VS5, |
| | 1VS6, 1VSA, 1VSP, 1W2B, 1XMQ, 1YL3, 1YL4, 2B9M, |
| | 2D3O, 2E5L, 2GY9, 2GYA, 2HGI, 2HGJ, 2HGP, 2HGR, |
| | 2HHH, 2I2P, 2I2T, 2J01, 2J03, 2J28, 2J37, 2OM7, 2OTJ, 2QA4, |
| | 2QBE, 2QEX, 2QOU, 2QOW, 2QOY, 2QP0, 2V46, 2VHM, |
| | 2VHN, 2VHO, 2WDI, 2WH1, 2WH2, 2WH4, 2ZJQ, 3BBN, |
| | 3BBO, 3BO0, 3CMA, 3D5A, 3D5B, 3D5D, 3DEG, 3F1E, 3F1F, |
| | 3FIC, 3FIH, 3FIK, 3FIN, 3G4S |
| RNA BINDING PROTEIN | 1D3B, 1JGN, 1JH4, 1JMT, 1N52, 1NT2, 1O0P, 1P27, 1Y96, |
| | 2BA0, 2BA1, 2DT7, 2F9D, 2FHO, 1UW4, 2J98, 2UY1, 2W2H |
| RNA BINDING PROTEIN/RNA | 1A9N, 2OZB |
| STRUCTURAL PROTEIN/RNA | 1YSH |
| TRANSFERASE/RNA | 1HVU |
| OTHER | 2APO, 2ZKR, 3CM8 |

In another embodiment of the present invention, the collection is a collection of protein secondary structures potentially involved in modulating cell signaling. Table 12 below is a list of PDB entries taken from Table 2 that contain secondary structures at the interface of a two-chain inter-protein interaction that are potentially involved in modulating cell signaling. A preferred collection according to the present embodiment contains about 1%, about 5%, about 10%, about 20%, about 40%, about 60%, about 80%, or about 100% of the protein secondary structures that are present in the PDB entries identified in Table 12.

TABLE 12
Representative HIPP Interactions Involved in Cell Signalling

| CLASSIFICATION | PDB CODE |
|---|---|
| ALU RIBONUCLEOPROTEIN PARTICLE | 1E8O |
| CELL CYCLE | 1DOA, 1F47, 1GO4, 1I2M, 1N2D, 1N4M, 1OTR, 1R4M, |
| | 1SA0, 1XEW, 2AFF, 2CCI, 2DFK, 2DOQ, 2GGM, 2GV5, |
| | 2I3S, 2I3T, 2K2I, 2OBH, 2QYF, 2RAW, 2RAX, 2V4Z, |
| | 2VE7, 2W96, 3DAB, 3DAC, 3DBH, 3EAB, 3EUH, 3EUK, |
| | 3FDO, 3G03, 3G33, 3G65, 3GGR |
| CIRCADIAN CLOCK PROTEIN | 1SUY, 1U9I |
| COMPLEX (GTP-BINDING/TRANSDUCER) | 1GG2, 1GOT, 1TBG |
| COMPLEX (INHIBITOR PROTEIN/KINASE) | 1BI8 |
| COMPLEX (SIGNAL | 1TCE |
| TRANSDUCTION/PEPTIDE) | |
| CYTOKINE | 1ES7, 1I1R, 1ICE, 1PGR, 2K03, 2PSM, 2VXS, 2VXT, 3D87 |
| CYTOKINE/CYTOKINE RECEPTOR | 2Q7N, 2B5I, 2Z3R, 3BPL, 3BPN, 3BPO, 3DI2, 3G9V |
| CYTOKINE/RECEPTOR | 1J7V, 2QJ9 |
| CYTOKINE/SIGNALING PROTEIN | 2O26, 3DGC, 3EJJ |
| G PROTEIN | 1ZBD |
| HORMONE | 1A7F, 1PID, 1VKT, 2K6T, 2K91, 2KBC, 2OM0, 3BDY, |
| | 3FUB, 7INS, 2FJH, 1M2Z |
| HORMONE RECEPTOR | 2ZSH, 3HHR, 3D48 |
| HORMONE(MUSCLE RELAXANT) | 6RLX |
| HORMONE/GROWTH FACTOR | 1BP3, 1BSX, 1K3M, 1KF9, 1M4U, 1PMX, 1RDT, 1T1K, |
| | 1XWD, 2ARP, 2GH0, 2H62, 2H67, 2H8B, 2NXX, 2OCF |
| HORMONE/GROWTH FACTOR RECEPTOR | 1DKF, 1QTY, 1R1K, 1R20, 1XDK, 1Z5X, 1RV6 |
| HORMONE/GROWTH FACTOR/HORMONE | 1F6F |
| RECEPTOR | |
| HORMONE/GROWTH | 2FDB |
| FACTOR/TRANSFERASE | |
| HORMONE/HORMONE RECEPTOR | 3D48 |
| HORMONE/SIGNALING PROTEIN | 3C9A |
| HYDROLASE/PROTEIN-BINDING | 1NU7, 1NU9, 1V5I, 1ZNV, 2G4D, 2PT7, 1UPT |
| INSULIN-LIKE BRAIN-SECRETORY | 1BOM |
| PEPTIDE | |
| ION CHANNEL/RECEPTOR | 1OED, 2BG9 |
| ISOMERASE/SIGNALING PROTEIN | 1X75 |
| LIGASE/SIGNALING PROTEIN | 2JMF |
| NERVE GROWTH FACTOR/TRKA | 1WWW |
| COMPLEX | |
| PROTEIN BINDING/HORMONE/GROWTH | 2DSQ, 2DSR |
| FACTOR | |
| PROTEIN-BINDING | 1IZN, 1L0O, 1OQP, 1X2T, 1YFN, 1ZL8, 1ZW3, 2ASQ, |
| | 2B87, 2DEN, 2DZN, 2FYZ, 2HYE, 2I94, 2IJ0, 2K3S, 2K8B, |
| | 2O98, 2ODB, 2R1T, 2VDB, 2ZL1, 3B71, 3CK4, 3CRP, |
| | 3DA7, 3DXC, 3F1I, 3GMW |
| PROTEIN-BINDING/HYDROLASE | 2IO1 |
| SIGNALING PROTEIN | 1B9X, 1CC0, 1CXZ, 1DEV, 1DS6, 1EMU, 1FQJ, 1G4U, |
| | 1G4Y, 1HE1, 1HV2, 1I4D, 1JDP, 1JJO, 1KI1, 1KJY, 1KMI, |
| | 1KZ7, 1LB1, 1MDU, 1MR1, 1NF3, 1OO0, 1OXK, 1P22, |
| | 1R5V, 1R5W, 1S1C, 1SHZ, 1T0J, 1U0S, 1U7F, 1U8T, |
| | 1WR1, 1XD2, 1Y3A, 1YOV, 1Z2C, 1ZC4, 2BAP, 2BBA, |
| | 2BWE, 2FHW, 2FU5, 2GCO, 2GTP, 2H7V, 2HJ9, 2IHB, |
| | 2IK8, 2JY6, 2K42, 2NTY, 2ODE, 2P1N, 2P6A, 2PBI, 2QQK, |
| | 2QQN, 2R4R, 2RIV, 2VRW, 2WG3, 2ZET, 3BH6, 3BJI, |
| | 3C7K, 3CX6, 3EG5, 3EDL, 3FAL, 3HO5, 1HL6, 3C59, |
| | 3F6Q, 3GNI, 2PL9, 1E0A, 2CNW, 1EAY, 1XCG, 2RGN, |
| | 1FOE, 2NZ8, 2IE3, 2NPP, 1T34, 2PK9, 2POP, 1P9M, 1PVH, |
| | 2D9Q, 3HH2, 3CF6, 1HH4, 1NIW, 1K5D, 2ZVN, 3GCG |
| SIGNALING PROTEIN/CELL ADHESION | 3D1M |
| SIGNALING PROTEIN, MEMBRANE | 1X86, 3BS5 |
| PROTEIN | |
| SIGNALING PROTEIN, TRANSFERASE | 1IB1, 2OZA, 2QME, 2ZFD, 2EHB |
| SIGNALING PROTEIN/APOPTOSIS | 2FJU |
| SIGNALING PROTEIN/HORMONE | 2QKH |
| SIGNALING PROTEIN/HYDROLASE | 2QIY, 2W2X, 3DOE |
| SIGNALING PROTEIN/LIPOPROTEIN | 2REX |
| SIGNALING PROTEIN/TRANSPORT | 3BC1 |
| PROTEIN | |
| TRANSFERASE/HORMONE | 2E9W |
| TRANSFERASE/SIGNALING PROTEIN | 2AUH, 3CZU, 3DGE, 3HEI |
| OTHER | 1A0O, 1CM1, 1AM4, 1GUA, 1WQ1, 1B6C, 1BI7, 1EFN, |
| | 1AGR, 1TX4, 1F45, 1I9R, 3EVS, 1EM8, 1KV6, 1L8C, |
| | 1LQB, 1S4Z, 1YKE, 2CZY, 2QXV, 2VPD, 2VPE, 2VPG, |
| | 1IYJ, 1MIU, 1N0W, 1MJE, 1CQT, 1D3U, 2H1O, 1IK9, |
| | 1UEL, 1OW3, 3A1Q, 2FO1, 3BRW, 1CN4, 3B4V, 2WC0, |
| | 2JRI, 2ZNV, 1H59, 3H9R, 1O9U, 2IZX, 1NEX, 1CUL, |
| | 2DWZ, 3EQY, 3FMO, 3FMP, 1KPE, 2RD0 |

In another embodiment of the present invention, the collection is a collection of protein secondary structures potentially involved in modulating cell structure or cellular adhesion. Table 13 below is a list of PDB entries taken from Table 2 that contain secondary structures at the interface of a two-chain inter-protein interaction that are potentially involved in modulating cell structure or cellular adhesion. A preferred collection according to the present embodiment contains about 1%, about 5%, about 10%, about 20%, about 40%, about 60%, about 80%, or about 100% of the protein secondary structures that are present in the PDB entries identified in Table 13.

TABLE 13
Representative HIPP Interactions Involved in Cell Structure or Adhesion

| CLASSIFICATION | PDB CODE |
|---|---|
| CELL ADHESION | 1DOW, 1I7W, 1J19, 1JPW, 1KUP, 1L5G, 1OHZ, 1QZ7, |
| | 1SYQ, 1TYE, 1U6H, 2CCL, 2D10, 2EMT, 2OZ4, 2P28, |
| | 2VN5, 2VZD, 2VZG, 2VZI, 2YVC, 3H2U, 3H2V, |
| CELL ADHESION, STRUCTURAL PROTEIN | 1RKE, 1YDI, 2GWW, 2IBF |
| CELL ADHESION/IMMUNE SYSTEM | 2VDN, 2VDO |
| COMPLEX (SKELETAL MUSCLE/MUSCLE | 1A2X |
| PROTEIN) | |
| CONTRACTILE PROTEIN | 1C0G, 1DFK, 1DFL, 1I84, 1J1D, 1J1E, 1M8Q, 1MVW, |
| | 1O18, 1QVI, 1RGI, 1YAG, 1YTZ, 1YV0, 2AKA, 2EC6, |
| | 2EKV, 2OS8, 3DTP, 1DFK, 1I84, 1J1E, 1M8Q, 1MVW, |
| | 1O18, 2EC6, 3DTP, 3B63 |
| CYTOSKELETAL PROTEIN | 2BTO |
| HYDROLASE/STRUCTURAL PROTEIN | 2B59, 2Z0E |
| MOTOR PROTEIN | 2KIN, 2VAS, 3DCO, 3KIN, 3H4S, 2BKI |
| MUSCLE PROTEIN | 1BR1, 1WDC, 2BL0 |
| STRUCTURAL PROTEIN/CONTRACTILE | 2FF6, 2V51, 2V52 |
| PROTEIN | |
| OTHER | 1H1V, 1XWJ, 1HLU, 2IX7, 1KXP, 3B63, 2DFS, 2AUS, |
| | 1MTP, 2G38, 2OPL, 3H6P, 3HHL, 1H8B, 1LUJ, 1M1E, |
| | 1MDU, 1MK9, 1MWN, 1NPQ, 1OZS, 1T60, 1Y64, 1ZAV, |
| | 2A40, 2A4J, 2ACM, 2BTQ, 2G9J, 2H7D, 2HL5, 2PBD, |
| | 2PG1, 2WBE, 3BYH, 3CHW, 3CIP, 3CJB, 3DWL, 3EDL, |
| | 3F3P, 2FV4, 2KBR, 3F7P, 3CJC, 1SQK, 3DAW, 1CJF |

In another embodiment of the present invention, the collection is a collection of protein secondary structures from toxins, viruses, or bacteria. Table 14 below is a list of PDB entries taken from Table 2 that contain secondary structures at the interface of a two-chain inter-protein interaction that are from toxins, viruses, or bacteria. A preferred collection according to the present embodiment contains about 1%, about 5%, about 10%, about 20%, about 40%, about 60%, about 80%, or about 100% of the protein secondary structures that are present in the PDB entries identified in Table 14.

TABLE 14
Representative HIPP Interactions of Toxins, Viruses, and Bacteria

| CLASSIFICATION | PDB CODE |
|---|---|
| ANTIBIOTIC RESISTANCE | 1E3A |
| BACTERIAL CELL DIVISION INHIBITOR | 1OFU |
| ENTEROTOXIN | 1HTL, 1LT4, 1TII |
| PROTEIN BINDING/TOXIN | 2O02 |
| PROTEIN BINDING/VIRAL PROTEIN | 2BL5 |
| PROTEIN BINDING/VIRUS/DNA | 1ZLA |
| TOXIN | 1BCP, 1ECI, 1KVD, 1PTO, 1R4P, 1R4Q, 1SB2, 1SR4, |
| | 1WQ9, 1XTC, 1XTG, 2F2F, 2OZN, 2ZOE, 3BPQ, 3BX4, |
| | 1TZN, 1UEX, 1GZS, 1HC9, 3BUZ, 2KC8, 1PTO |
| TOXIN INHIBITOR/TOXIN | 2A6Q |
| TOXIN/ANTITOXIN | 3DBO, 3G5O, 3H87 |
| TOXIN/PROTEIN BINDING | 2NYD |
| TOXIN/TOXIN INHIBITOR | 1TFO |
| TUBERCULOSIS | 1WA8 |
| VIRAL PROTEIN | 1C8O, 1FAV, 1G2C, 1JEK, 1JMU, 1JSD, 1JSM, 1M93, |
| | 1QRJ, 1RD8, 1RU7, 1RUY, 1RUZ, 1SVF, 1T6O, 1TI8, 1ZV8, |
| | 2BEQ, 2BEZ, 2FK0, 2GOL, 2H1L, 2IBX, 2RFT, 3DNL, |
| | 3DS3, 3EPC, 3EPD, 3EPF, 3EYJ, 3EYM, 3GBM, 1JXP, |
| | 2NZ1, 2Z2T, 3HHZ, 3CL3 |
| VIRAL PROTEIN, RECOMBINATION | 2B4J, 3F9K |
| VIRAL PROTEIN, REPLICATION | 2AHM |
| VIRAL PROTEIN/TRANSLATION | 1LJ2 |
| VIRAL PROTEIN/APOPTOSIS | 3BL2, 3DVU |
| VIRAL PROTEIN/IMMUNE SYSTEM | 1A3R, 1AFV, 1EO8, 1F58, 1FRG, 1G9M, 1KEN, 1KG0, |
| | 1QFU, 1YYL, 1ZTX, 2B4C, 2NY7, 2QAD, 3BGF, 3FKU, |
| | 3GBN |
| VIRAL PROTEIN/NUCLEAR PROTEIN | 2RHK |
| VIRAL PROTEIN/SIGNALING PROTEIN | 3CL3 |
| VIRUS | 1AL0, 1B35, 1BBT, 1BEV, 1D4M, 1EAH, 1EV1, 1FMD, |
| | 1NY7, 1OOP, 1PIV, 1POV, 1R1A, 1RHI, 1TME, 1UF2, |
| | 1Z7S, 1Z8Y, 1ZBA, 2BTV, 2MEV, 2QQP, 2W0C, 3CJI, |
| | 3GZU, 1QGC, 1RVF |
| VIRUS/DNA | 2BPA |
| VIRUS/RECEPTOR | 1V9U, 1Z7Z, 2JIK |
| VIRUS/RNA | 1BMV, 1F8V, 2BBV, 2Q26 |
| OTHER | 2GYK, 2PF4, 2PKG, 2AJF, 1YRT, 3DCG, 1N 0V |

In another embodiment of the present invention, the collection is a collection of protein secondary structures potentially involved in modulating gene transcription. Table 15 below is a list of PDB entries taken from Table 2 that contain secondary structures at the interface of a two-chain inter-protein interaction that are potentially involved in modulating gene transcription. These two-chain inter-protein interactions include transcriptional activators, repressors, or other components of the transcription machinery. A preferred collection according to the present embodiment contains about 1%, about 5%, about 10%, about 20%, about 40%, about 60%, about 80%, or about 100% of the protein secondary structures that are present in the PDB entries identified in Table 15.

TABLE 15
Representative HIPP Interactions Involved in Transcription

| CLASSIFICATION | PDB CODE |
|---|---|
| IMMUNE SYSTEM | 1OQD, 1BM3, 1BX2, 1BZ7, 1C12, 1C5B, 1C5D, 1CL7, 1CT8, 1CU4, |
| | 1CZ8, 1D9K, 1DEE, 1DN0, 1DQQ, 1DZB, 1ED3, 1EFX, 1EJO, 1ETZ, |
| | 1F11, 1F3D, 1F3J, 1F4W, 1F90, 1FE8, 1FG9, 1FH5, 1FJ1, 1FL5, |
| | 1FN4, 1FNS, 1FSK, 1FYH, 1G0Y, 1H0T, 1HDM, 1HQ4, 1HQR, |
| | 1HYR, 1I1A, 1I3R, 1I7Z, 1IL1, 1IM9, 1J8H, 1JGL, 1JGV, 1JL4, |
| | 1JNH, 1JNL, 1JPS, 1K8I, 1KC5, 1KCG, 1KCS, 1KFA, 1KJ2, 1KN2, |
| | 1KTD, 1KTK, 1L0X, 1L7T, 1LK3, 1LO0, 1LO4, 1LP1, 1LP9, 1LQS, |
| | 1MEX, 1MHP, 1MI5, 1MUJ, 1MVF, 1MWA, 1N0X, 1NAK, 1NC2, |
| | 1ND0, 1NGW, 1NJ9, 1NL0, 1OEY, 1OQO, 1P4B, 1PG7, 1PZ5, 1Q1J, |
| | 1Q72, 1Q9O, 1Q9W, 1R24, 1RHH, 1RIH, 1RJL, 1RZ7, 1RZF, 1RZG, |
| | 1RZI, 1S3K, 1S9V, 1SEQ, 1T4K, 1T66, 1TZH, 1TZI, 1U3H, 1UM4, |
| | 1UWX, 1UYW, 1W72, 1XCQ, 1XCT, 1XGP, 1YMM, 1YNK, 1YNT, |
| | 1YPZ, 1YY8, 1Z92, 1ZA6, 1ZAN, 1ZGL, 2A9M, 2AAB, 2ADG, |
| | 2AGJ, 2AI0, 2AJ3, 2AJZ, 2AK4, 2AP2, 2AQ1, 2ARJ, 2BC4, 2BDN, |
| | 2BRR, 2CMR, 2D03, 2DQT, 2E7L, 2EH8, 2ESV, 2F54, 2FJF, 2FL5, |
| | 2FX8, 2G2R, 2G60, 2G75, 2G9H, 2GJZ, 2GSI, 2HFG, 2HH0, 2HWZ, |
| | 2I26, 2I26, 2IAM, 2IAN, 2ICE, 2ICW, 2IPK, 2IPU, 2J5L, 2NNA, |
| | 2NOJ, 2NTF, 2NX5, 2O5X, 2OI9, 2OJZ, 2OQJ, 2OSL, 2P24, 2PXY, |
| | 2Q6W, 2Q86, 2Q8A, 2QEJ, 2QKI, 2QR0, 2RD7, 2UYL, 2V17, 2V7H, |
| | 2V7N, 2VL5, 2VLJ, 2VLR, 2VOL, 2VQ1, 2VWE, 2VXU, 2VXV, |
| | 2VYR, 2W65, 2W80, 2W9E, 2WBJ, 2WII, 2WIN, 2Z4Q, 2Z7X, 2Z8V, |
| | 2Z91, 2ZCK, 2ZPK, 32C2, 3BKJ, 3BKY, 3BQU, 3BT2, 3BZ4, 3C8K, |
| | 3CDG, 3CFB, 3CFD, 3CFK, 3CLE, 3CMO, 3CUP, 3CVH, 3D0L, |
| | 3D5O, 3D69, 3DGG, 3DIF, 3DVG, 3DXA, 3E3Q, 3E8U, 3EFD, |
| | 3EYF, 3EYQ, 3FFC, 3G04, 3G6A, 3G6D, 3G6J, 3GIZ, 3GJF, 3HAE, |
| | 3HC0, 3HE6, 3HE7, 3HG1, 3HNS, 3HRZ, 3HS0, 3HUJ, 3I2C, 7CEI, |
| | 1UVQ, 3GKW, 2FD6, 2FHZ, 2FSE, 3H0T, 2H9G, 1IQD, 1UJ3, 1Z3G, |
| | 3EOA, 1V7N, 2ERJ, 3D85, 3DUH, 3EO1, 1CBV, 1KEG, 2FR4, 3FFD, |
| | 3F8U, 1HH9, 1YJD, 1ZA3, 1HXY, 1LO5, 3ETB, 3B2U, 3GKW, |
| | 2FD6, 2FHZ, 2FSE, 1D9K, 1I3R, 1ZGL, 2GJ7 |
| TRANSCRIPTION | 1CI6, 1E 50, 1F3U, 1F93, 1FM6, 1FMH, 1G1E, 1HQM, 1I3Q, 1K3Z, |
| | 1K74, 1K7L, 1KBH, 1KKQ, 1L3E, 1LKY, 1MK2, 1MZN, 1NIK, |
| | 1NRL, 1ONV, 1OR7, 1OVL, 1PD7, 1PZL, 1R2B, 1RP3, 1S5R, 1SB0, |
| | 1SV0, 1TFC, 1TIL, 1U2U, 1VCB, 1WCM, 1XLS, 1YOK, 1ZDT, |
| | 2ACL, 2AGH, 2BZW, 2D5R, 2DVQ, 2E3K, 2FEP, 2FMM, 2GL7, |
| | 2GPP, 2GPV, 2GS0, 2HZM, 2HZS, 2IZV, 2JBA, 2JF9, 2JFA, 2K7L, |
| | 2NNU, 2NPI, 2NS8, 2NZU, 2O9I, 2P7V, 2PHE, 2PHG, 2Q0O, 2RMS, |
| | 2RNR, 2V5H, 2VUS, 2WAQ, 2WB1, 2Z2S, 2ZNL, 3BLH, 3BP8, |
| | 3C0T, 3D24, 3D3C, 3DGP, 3DOM, 3E1K, 3F5C, 3FBI |
| TRANSCRIPTION | 1H2M |
| ACTIVATOR/INHIBITOR | |
| TRANSCRIPTION REGULATION | 1UTB, 1YUC, 2CPW |
| TRANSCRIPTION REGULATION | 1BH8, 1KDX |
| COMPLEX | |
| TRANSCRIPTION REGULATOR | 1B0N, 2KA4, 2KA6, 2P5T, 3BEJ, 3C8G |
| TRANSCRIPTION REPRESSION | 1PK1 |
| TRANSCRIPTION REPRESSOR, CELL | 3BIM |
| CYCLE | |
| TRANSCRIPTION, TRANSCRIPTIONREGULATION | 3ECH |
| TRANSCRIPTION, TRANSFERASE/DNA- | 3ERC, 3GTM, 3HOU, 3HOY |
| RNA HYBRID | |
| TRANSCRIPTION/CELL CYCLE | 2OVQ |
| TRANSCRIPTION/DNA | 1A02, 1AWC, 1C9B, 1CF7, 1FOS, 1IHF, 1IO4, 1JFI, 1JFI, 1MDY, |
| | 1MNM, 1NGM, 1NH2, 1NKP, 1NLW, 1NVP, 1O4X, IR0N, 1RIO, |
| | 1RM1, 1S9K, 1T2K, 1XS9, 1ZVV, 2F8X, 2HAN, 2QL2, 2R5Y, 3DZU |
| TRANSCRIPTION/PROTEIN | 1TQE |
| BINDING/DNA | |
| TRANSCRIPTION/TBP-ASSOCIATED | 1H3O |
| FACTORS | |
| TRANSCRIPTION/TRANSFERASE | 1P4Q, 1XIU, 1ZOQ, 3GFK |
| TRANSCRIPTIONAL COACTIVATOR | 1OJH |
| TRANSFERASE/TRANSCRIPTION | 2JZB, 2K8F, 2WIU, 3BRT, 3BRV |
| OTHER | 1TBA, 3HQR, 1SSE, 2AVU, 1L2I, 3EU7, 1ZHI, 1R8U, 3DCT, 1RZR, |
| | 2AJQ |

In another embodiment of the present invention, the collection is a collection of protein secondary structures potentially involved in modulating cellular transport. Table 16 below is a list of PDB entries taken from Table 2 that contain secondary structures at the interface of a two-chain inter-protein interaction that are potentially involved in modulating cellular transport. A preferred collection according to the present embodiment contains about 1%, about 5%, about 10%, about 20%, about 40%, about 60%, about 80%, or about 100% of the protein secondary structures that are present in the PDB entries identified in Table 16.

TABLE 16
Representative HIPP Interactions Involved in Transport

| CLASSIFICATION | PDB CODE |
|---|---|
| ENDOCYTOSIS | 1W63, 2JKR, 2JXC, 2IV8, 2G3Q |
| ENDOCYTOSIS/EXOCYTOSIS | 1JTH, 1L4A, 2EQB, 2G30, 2OCY, 2PJW, 2PJX, 3C98 |
| EXOCYTOSIS | 2CJS, 3HD7 |
| HYDROLASE ACTIVATOR/PROTEIN | 2G77 |
| TRANSPORT | |
| HYDROLASE/TRANSPORT PROTEIN | 2R6G, 2ZXE, 3B8E |
| LIPID TRANSPORT/ENDOCYTOSIS/ | 2FCW |
| CHAPERONE | |
| METAL BINDING PROTEIN/TRANSPORT | 2BEC, 2E30 |
| PROTEIN | |
| METAL TRANSPORT | 1EXB, 1SUV |
| METAL TRANSPORT, HYDROLASE | 2PMS, 3CJK |
| METAL TRANSPORT, MEMBRANE | 2A5T |
| PROTEIN | |
| OXIDOREDUCTASE/LIPID TRANSPORT | 3EJB |
| OXIDOREDUCTASE/METAL | 1WX5, 1ZRT |
| TRANSPORT | |
| OXYGEN STORAGE, OXYGEN | 2RI4, 3D4X, 3DHR, 3DHT, 3FS4, 1XQ5 |
| TRANSPORT | |
| OXYGEN STORAGE/TRANSPORT | 1FHJ, 1FSX, 1GCV, 1HBR, 1HV4, 1JEB, 1JY7, 1V4U, 1V75, |
| | 1XQ5, 1Y8H, 1YHU, 2AA1, 2D2M, 2GTL |
| OXYGEN TRANSPORT | 1A9W, 1CG5, 1FDH, 1HDS, 1OUU, 1QPW, 1SCT, 2W72, |
| | 3FH9, 3HRW |
| PROTEIN TRANSPORT | 1J2J, 1NRJ, 1R4A, 1RE0, 1RH5, 1RJ9, 1TU3, 1UKV, 1W7P, |
| | 1X79, 1YHN, 1Z0J, 1Z0K, 2BSK, 2C5I, 2D3G, 2D7C, 2GZD, |
| | 2H4M, 2HV8, 2J9U, 2JDQ, 2JQ9, 2JQK, 2K3W, 2K8M, 2NUP, |
| | 2OT3, 2PM6, 2QTV, 2QTV, 2R17, 2RET, 2V6X, 2V8S, 2VDA, |
| | 2VGL, 2W83, 2W84, 2W85, 2ZME, 3CI0, 3CJH, 3CPH, 3CPJ, |
| | 3CQC, 3CQG, 3CUE, 3CUQ, 3DL8, 3DXR, 3EZJ, 3GJX, |
| | 1YD8, 1UKL, 2ZJS, 3CFI, 2C1M, 3DKN, 1M2O, 1WR6, |
| | 1WRD, 2FNJ, 2A5D |
| PROTEIN TRANSPORT, HYDROLASE | 3BG0 |
| PROTEIN TRANSPORT, MEMBRANE | 3DEP |
| PROTEIN | |
| PROTEIN TRANSPORT, ANTIMICROBIAL | 2HDI |
| PROTEIN | |
| PROTEIN TRANSPORT/EXCHANGE | 1R8Q |
| FACTOR | |
| PROTEIN TRANSPORT/SPLICING | 3BBP |
| TRANSPORT PROTEIN | 2J3R, 2J3W, 1IA0, 1JN5, 1MO1, 1S6C, 1SFC, 1T3L, 1U5T, |
| | 1URQ, 1VYT, 1Y74, 1Y76, 2BH1, 2EFC, 2F66, 2I2R, 2NPS, |
| | 2OT8, 2P22, 2P4N, 2QMB, 2QNA, 3C3Q, 3CWZ, 3D31, 3D32, |
| | 3EA5, 3FH6 |
| TRANSPORT PROTEIN/CHAPERONE | 2P58 |
| TRANSPORT PROTEIN/LIPOPROTEIN | 2HQS |
| TRANSPORT PROTEIN/OXYGEN | 3BCQ |
| BINDING | |
| TRANSPORT PROTEIN/SIGNALING | 2NUU |
| PROTEIN | |
| OTHER | 3FIE, 3BPS, 1KPS, 1DE4, 1KKL, 1LOT, 1UJW, 3BSZ, 2C0L |

Another aspect of the present invention relates to methods of screening therapeutic drug candidates to identify candidates that are potentially effective in modulating two-chain inter-protein interactions having a secondary structure at their interface. These methods involve selecting a protein secondary structure from among a collection of protein secondary structures described herein. In one embodiment, a therapeutic drug candidate is contacted with an agent that mimics the protein secondary structure (i.e., secondary structure mimetic). The drug candidate and mimetic agent are contacted under conditions effective for the therapeutic drug candidate to bind to the agent and binding between the therapeutic drug candidate and the agent is detected. Detecting binding between the therapeutic drug candidate and the agent indicates that the therapeutic drug candidate is potentially effective in modulating a two-chain inter-protein interaction having the protein secondary structure at its interface.

In another embodiment, a therapeutic drug candidate that mimics the protein secondary structure is provided. The therapeutic drug candidate is contacted with at least one protein (or a fragment thereof) involved in a two-chain inter-protein interaction having the protein secondary structure at its interface under conditions effective for the therapeutic drug candidate to bind to the at least one protein (or fragment), and binding between the therapeutic drug candidate and the at least one protein (or fragment) is detected. Detecting binding between the therapeutic drug candidate and the at least one protein (or fragment) indicates that the therapeutic drug candidate is potentially effective in modulating the two-chain inter-protein interaction.

Protein secondary structure mimics that are suitable for use as a drug candidate or as the target for a drug candidate in the above described methods of screening preferably comprise a molecular scaffold. Various molecular scaffolds of secondary structure are known in the art and can be modified in various ways to mimic the interaction interface residues, especially the hot-spot amino acid residues of the interaction, that have been identified using the methods of the present invention.

One type of molecular scaffold suitable for mimicking the identified secondary structures are protein surface scaffolds such as miniature protein motif scaffolds, which integrate the desired functionalities of a two-chain inter-protein interaction interface onto a stably folded structural peptide framework (Imperiali et al., “Design Strategies for the Construction of Independently Folded Polypeptide Motifs,” Biopolymers 47:23-29 (1998); Nygren et al., “Binding Proteins from Alternative Scaffolds,” J. Immunol. Methods 290:3-28 (2004), which are hereby incorporated by reference in their entirety). Other suitable protein surface scaffolds include porphyrin and bipyridyl-metal complex scaffolds (Jain et al., “Protein Surface Recognition by Synthetic Recptors Based on Tetraphenylporphyrin Scaffold,” Org. Lett. 2:1721-23 (2000); Takashima et al, “Ru(bpy)(3)-based Artificial Receptors Toward a Protein Surface: Selective Binding and Efficient Photoreduction of Cytochrome C,” Chem. Comm. 2345-46 (1999), which are hereby incorporated by reference in their entirety), calixarene scaffolds (Blaskovich et al., “Design of GFB-111, A Platelet-Derived Growth Factor Binding Molecule with Antiangiogenic and Anticancer Activity Against Human Tumors in Mice,” Nat. Biotechnol. 18:1065-70 (2000), which is hereby incorporated by reference in its entirety), naphthalene and quinoline-based scaffolds (Xu et al., “Evaluation of ‘Credit Card’ Libraries for Inhibition of HIV-1 gp41 Fusogenic Core Formation,” J. Comb. Chem. 8:531-39 (2006), which is hereby incorporated by reference in its entirety), and cyclodextrins (Breslow et al., “Sequence Selective Binding of Peptides by Artificial Receptors in Aqueous Solution,” J. Am. Chem. Soc. 120:3536-37 (1998), which is hereby incorporated by reference in its entirety).

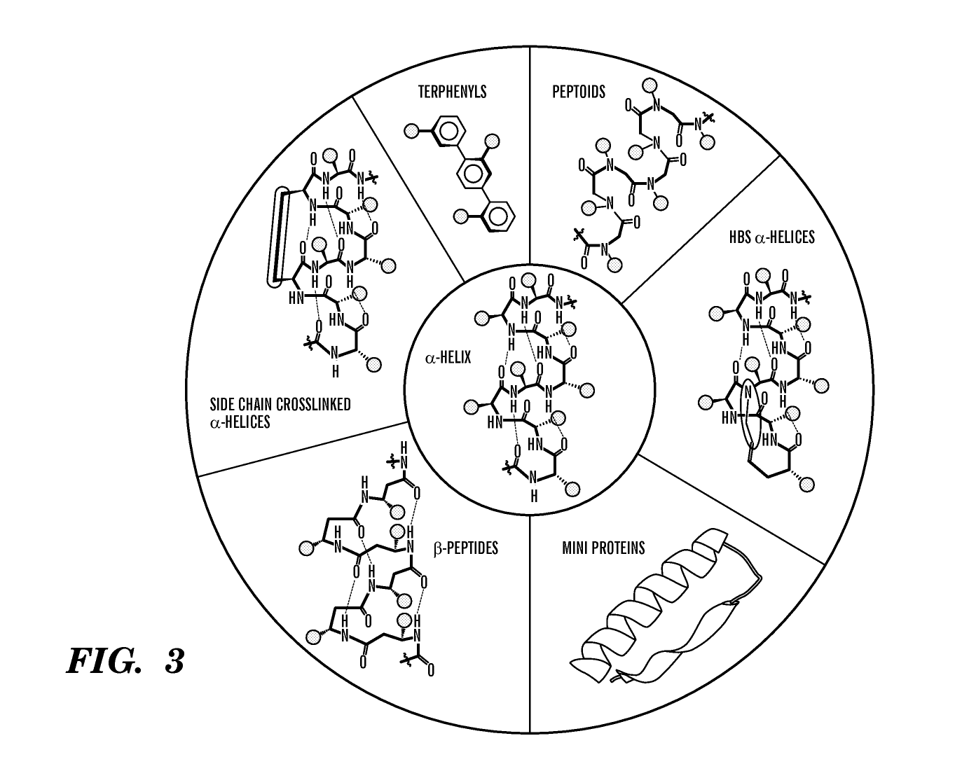

A preferred class of agents for mimicking helical protein secondary structures include α-helix mimetic scaffolds. Suitable α-helical modular synthetic scaffolds include terphenyl derivatives (FIG. 3; Orner et al., “Toward Proteomimetics: Terphenyl Derivative as Structural and Functional Mimics of Extended Regions of an α-Helix,” J. Am. Chem. Soc. 123:5382-83 (2001), which is hereby incorporated by reference in its entirety), trispyridylamide derivatives (Ernst et al., “Design and Application of an α-Helix-Mimetic Scaffold Based on an Oligoamide-Foldamer Strategy: Antagonism of the Bak BH3/Bc1-xL Complex,” Angew. Chem. Int. Ed. 42:535-39 (2003), which is hereby incorporated by reference in its entirety), terephthalamide derivatives (Yin et al., “Terephthalamide Derivatives as Mimetics of Helical Peptides: Disruption of the Bc1-x(L)/Bak Interaction,” J. Am. Chem. Soc. 127:5463-68 (2005), which is hereby incorporated by reference in its entirety), terpyridine derivatives (Davis et al., “Synthesis of a 2,3′;6′3″-terpyridine Scaffold as an α-Helix Mimetic,” Org. Lett. 7:5405-08 (2005), which is hereby incorporated by reference in its entirety), and bisimidazole derivatives (VanCompernolle et al., “Small Molecule Inhibition of Hepatitis C Virus E2 Binding to CD81,” Virology 314:371-80 (2003), which is hereby incorporated by reference in its entirety). Other α-helical mimetics include β-peptides and peptoids (both shown in FIG. 3), constrained helices, and small molecule mimetics (e.g., 1,4-benzo-diazepine-2,5-diones, 3-hydroxymethylindole, and polycyclic ethers) (reviewed in Herschberger et al., “Scaffolds for Blocking Protein-Protein Interactions,” Curr. Top. Med. Chem. 7:928-42 (2007), which is hereby incorporated by reference in its entirety) and side-chain cross-linked α-helices (FIG. 3). In a preferred embodiment, the α-helical mimetic is a hydrogen-bond surrogate (“HBS”) backbone cross-linked α-helix described in U.S. Pat. No. 7,202,332 to Arora et al., which is hereby incorporated by reference in its entirety.

β-Strand and β-turn secondary structure mimetic scaffolds are also suitable for mimicking the secondary structures that are at an interface of a two-chain inter-protein interaction. β-strand mimetics, which are typically designed to modulate protein-protease interactions, include the crosslinked β-strand mimetic scaffolds (see e.g., Zutshi et al., “Targeting the Dimerization Interface of HIV-1 Protease: Inhibition with Cross-Linked Interfacial Peptides,” J. Am. Chem. Soc. 119:4841-45 (1997), which is hereby incorporated by reference in its entirety) and peptidomimetic β-strand mimetic scaffolds. The peptidomimetic β-strand mimetics may contain various ring systems, including six-membered piperidine rings, pyridine rings, and pyrrolinone rings; cyclic urea complexes; or azacyclohexenone units incorporated into the peptide backbones (reviewed in Herschberger et al., “Scaffolds for Blocking Protein-protein Interactions,” Curr. Top. Med. Chem. 7:928-42 (2007), which is hereby incorporated by reference in its entirety). Suitable β-turn mimetic scaffolds include β-D-glucose scaffolds (Hirschmann et al., “Nonpeptidal Peptidomimetics with a Beta-Glucose Scaffolding—A Partial Somatostatin Agonist Bearing a Close Structural Relationship to a Potent, Selective Substance-P Antagonist,” J. Am. Chem. Soc. 114:9217-18 (1992), which is hereby incorporated by reference in its entirety), constrained structural mimetics to mimic type I β-turns (Etzkorn et al., “Cyclic Hexapeptides and Chimeric Peptides as Mimics of Tendamistat,” J. Am. Chem. Soc. 116:10412-25 (1994), which is hereby incorporated by reference in its entirety), and conformationally constrained cyclic scaffolds (Virgilio et al., “Simultaneous Solid-Phase Synthesis of Beta-Turn Mimetics Incorporating Side Chain Functionality,” J. Am. Chem. Soc. 116:11580-81 (1994); Maliartchouk et al., “A Designed Peptidomimetic Agonistic Ligand of TrkA Nerve Growth Factor Receptors,” Mol. Pharmacol. 57:385-91 (2000); Ulysse et al., “A Light Activated β-Turn Scaffold Within a Somatostatin Analog: NMR Structure and Biological Activity,” Chem. Biol. Drug Des. 67:127-36 (2006), which are hereby incorporated by reference in their entirety). The non-peptidic oligomers described in U.S. Patent Publication No. 20070105917 to Arora et al., which is hereby incorporated by reference in its entirety, are also suitable secondary structure mimetics that can be used in accordance with this aspect of the present invention.

Suitable screening assays for identifying potentially therapeutic drug candidates can be in silico, in vitro, or ex vivo based assays.

In silico or virtual screening assays are particularly useful for evaluating the binding between a secondary structure mimetic and a drug candidate for the identification of a protein binding pocket. A number of web-based programs and databases, such as Molsoft, exist to facilitate in silico screening and are suitable for use in accordance with this aspect of the invention. Villoutreix et al., “Free Resources to Assist Structure-Based Virtual Ligand Screening Experiments,” Curr. Protein Pept. Sci 8(4):381-411 (2007), which is hereby incorporated by reference in its entirety, provides over 350 URLs to various free web-based applications and services for in silico screening.

In another embodiment of the present invention, the screening assay is an in vitro screening assay designed to detect a binding interaction between two potential binding partners. A number of in vitro screening assay formats are commercially available, for example AlphaScreen™ from Perkin Elmer®, that are particularly suitable for carrying out this aspect of the present invention. AlphaScreen is a bead-based chemistry, where members of the binding interaction (e.g., the secondary structure mimetic agent and therapeutic drug candidate, or the secondary structure mimetic drug candidate and protein involved in the two-chain inter-protein interaction) are bound to donor and acceptor beads, respectively. Binding between the members of the potential interaction brings the donor and acceptor beads in close proximity, facilitating energy transfer and light production that is detected at defined excitation/emission spectra.

An alternative in vitro screening assay format is a solid-phase assay, where one member of the potential binding interaction (e.g., the secondary structure mimetic agent) is attached to a solid support and the other member of the binding interaction (e.g., the drug candidate) contains a detectable label. Suitable detectable labels include fluorescent molecules, enzymes, prosthetic groups, luminescent materials, bioluminescent materials, radioactive materials, positron emitting metals using various positron emission tomographies, and nonradioactive paramagnetic metal ions.

Surface plasmon resonance (SPR)-based biomolecular interaction analysis is an alternative in vitro screening strategy suitable for detection of a binding interaction between a therapeutic drug candidate and a secondary structure mimetic agent (or between a secondary structure mimetic therapeutic drug candidate and a protein involved in a two-chain inter-protein interaction). In this assay format, one member of the binding interaction is immobilized on a biosensor chip. A microfluidic system injects an analyte solution containing the other interacting molecule over the sensor surface. Binding of the two members is qualitatively assessed in real-time using SPR-biosensors that visualize and measure the binding interaction based on the change in mass concentration that occurs on the sensor chip surface during the binding and dissociation process.

In another embodiment of the present invention, the screening assay is an ex vivo screening assay designed to detect (or, more preferably, validate) a binding interaction between the two members of the potential interaction. For example, an ex vivo assay where live cells expressing both proteins of a two-chain inter-protein interaction having the secondary structure at their interface are contacted with the therapeutic drug candidate (e.g., a secondary structure mimetic). The ability of the drug candidate to modulate the two-chain inter-protein interaction is detected by assaying a downstream biological function of the two-chain inter-protein interaction.

Suitable endpoints to measure will depend on the protein interaction being examined, but may include, for example, gene transcription, kinase activity, DNA binding, enzyme activity, or other cell signaling activities.

In another embodiment of the present invention, the screening assay is an in vivo screening assay designed to detect, or more preferably, validate a binding interaction between the two members of the potential two-chain inter-protein interaction. For example, an in vivo assay may involve treating an animal that expresses both proteins of a two-chain inter-protein interaction having a secondary structure at their interface with a therapeutic drug candidate (e.g. a secondary structure mimetic). The ability of the drug candidate to modulate the two-chain inter-protein interaction is detected by assaying a downstream biological function of the two-chain inter-protein interaction in the animal. Suitable endpoints to measure will depend on the protein interaction being examined, but may include, for example, gene transcription, kinase activity, DNA binding, enzyme activity, or other cell signaling activities.

### EXAMPLES

### Example 1

### Identification of Helical Interfaces in Protein-Protein Interactions

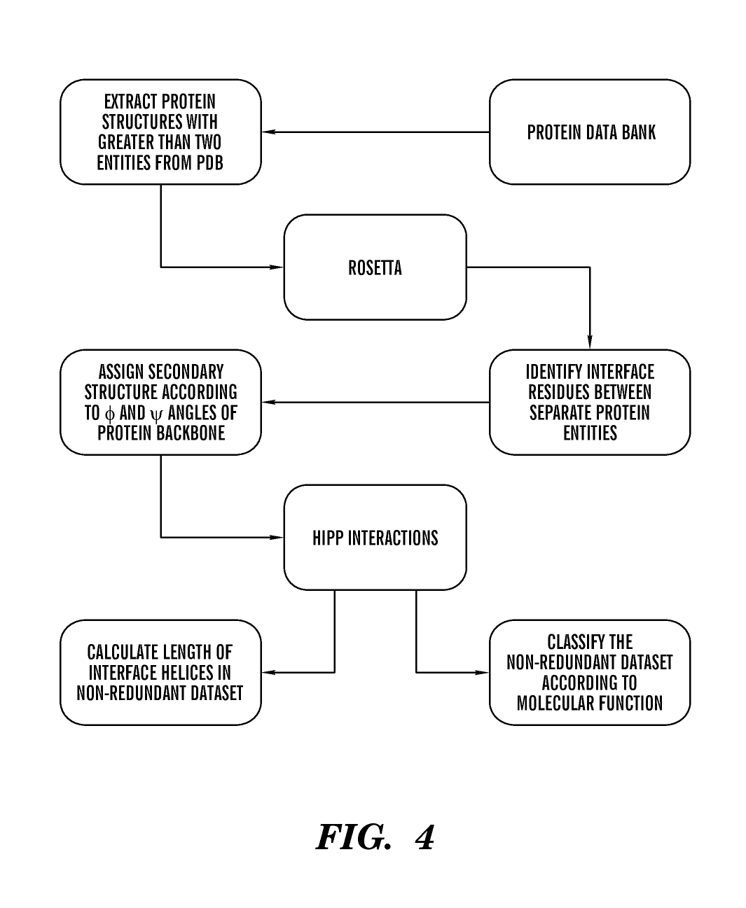

The methodology utilized to identify helical interfaces in protein-protein interactions is outlined in FIG. 4. Protein structures containing more than one protein entity were obtained from the Protein Data Bank (PDB) using the advanced search function available on the website and stored in a parent PDB file. A Perl script to construct individual PDB files for each interacting protein chain within the parent PDB file was developed. This script reads a PDB file, identifies atoms from different chains that interaction with each other, then creates a new formatted PDB file with those two chains. This process is repeated until all interacting chains have a new PDB file. If the parent PDB file contains more than one structure, only the first structure is considered.

A second Perl script to identify protein partner chains between separate entities was developed. This script reads a PDB file, identifies chains that belong to separate entities within the PDB file, and creates a list of the PDB code and partnering chains that are part of the separate entities. This enables the identification of those helix interfaces that are between separate protein entities, i.e., inter-protein interactions, as opposed to helical interfaces between chains in a single protein, i.e., intra-protein interactions.

Having identified the inter-protein interactions, modifications to Rosetta© computational tools, written in C++ programming language, were utilized to identify helical interfaces between interacting protein chains. Rosetta© contains separate programs that identify interface residues and assigns secondary structure to a protein backbone. The computer program code developed here links these two routines to find protein chains with interface residues that lie within a helix. A helical segment was defined as one that contains at least four contiguous residues with φ and φ angles that are characteristic of the α-helix (φ=−57°±50°, φ=−47°±50°). Often, protein-protein interfaces are defined according to geometrically continuous patches of residues on the surface of a protein that exclude solvent by binding to another chain. This definition might include some residues that are not really involved in the interaction or exclude some residues that play a key role in the interaction. Therefore, a distance threshold between residues of different chains was used.

An interface residue is defined as (i) a residue that has at least one atom within a 5 Å radius of an atom belonging to a binding partner in the protein complex, or (ii) a residue that becomes significantly buried upon complex formation, as measured by the density of C_{β} atoms within a sphere with a radius of 5 Å around the C_{β} atom of the residue of interest.

The length of each helix involved in helical interface protein-protein interactions was calculated using a C++ program.

The PDB structures involved in helical interface protein-protein interactions were classified according to molecular function. The categories were derived from those listed in the ‘Advanced Search’ option on the PDB website.

The PDB contains more than 55,000 structures (Berman et al., “The Protein Data Bank,” Nucleic Acids Res. 28:235-242 (2000), which is hereby incorporated by reference in its entirety). Approximately 80% of these structures contain a single protein entity and 4% contain no protein entities. The remaining 16%, or about 8,678 structures, contain more than two separate protein entities and form the dataset for evaluation of helical interfaces in protein-protein interactions (“HIPP interactions”) (FIG. 5A). A computer analysis of this dataset revealed that 13% contained HIPP interactions. These complexes may also contain other secondary motifs, but the current study focuses solely on the helical portions.

In an initial analysis, a dataset of 7,066 HIPP interactions were identified. This dataset is disclosed in U.S. Provisional Patent Application Ser. No. 61/166,211 and Jochim et al., “Assessment of Helical Interfaces in Protein-Protein Interactions,” Mol. Biosyst. 5(9):924-6 (2009), which are hereby incorporated by reference in their entirety. The identified 7,066 HIPP complexes contain considerable redundancy in sequence and structure owing to the redundancy in the PDB. Structures with greater than 95% sequence similarity were removed with the CD-HIT algorithm (Li et al., “Clustering of Highly Homologous Sequences to Reduce the Size of Large Protein Databases,” Bioinformatics 17:282-283 (2001), which is hereby incorporated by reference in its entirety) to obtain a better understanding of the types of complexes involved in HIPP interactions. This screen provided a non-redundant dataset of 1,658 HIPP interactions for analysis, which is disclosed in U.S. Provisional Patent Application Ser. No. 61/166,211 and Jochim et al., “Assessment of Helical Interfaces in Protein-Protein Interactions,” Mol. Biosyst. 5(9):924-6 (2009), which are hereby incorporated by reference in their entirety.

The CD-HIT algorithm used to remove the redundant interactions searches the sequence information of each chain of an interaction from the PDB FASTA file. Using this algorithm, however, redundant two-chain and single chain interactions were removed. Therefore, to ensure that only redundant two-chain interactions were removed (rather than redundant single chains), the chain identifier was removed from the FASTA file of the PDB entries in the dataset of 7,066 interactions and then the CD-HIT algorithm search was reexecuted, so that the entire amino acid sequence of the protein-protein complex is searched rather than just the individual protein chains. Using this approach, a non-redundant dataset of 2,561 HIPP interactions for analysis was identified, which is shown in Table 2 above. The helical two-chain inter-protein interactions of the non-redundant dataset are identified by their PDB code and function of the protein complex. In addition, the partner chains, helix size, number of hot-spot residues, and helix amino acid sequence are also identified. The helical inter-protein interactions are ranked by ΔΔG_{SUM} (Kcal/mol), which represents the sum of binding free energy for all hot spot residues in each helix. The ΔΔG_{AVE} (Kcal/mol), representing the sum of binding free energy for all hot spot residues in each helix divided by the number of hot spot residues in that helix, is also provided for each helical inter-protein interaction. The binding free energy values can be used to identify inter-protein interactions that can be easily targeted by helix mimetics or small molecule inhibitors. For example, inter-protein interactions having energy values of 3.0 kcal/mol and higher can be targeted by either helix mimetics or small molecule inhibitors. Inter-protein interactions having energy values in the range of 1.5-2.0 kcal/mol are more difficult to target with small molecules; however, these interactions can be targeted by helix mimetics.

The hot-spot residues of the helical two-chain inter-protein interactions of Table 2 were also identified and are show in Table 17 below. Hot spot residues within each interaction are identified by the PDB code of the protein complex, partner chain, residue number, and amino acid residue. The ΔΔG (Kcal/mol) for each hot spot residue is also provided. There were 43,397 hot-spot residues identified in the 2,561 HIPP interactions.

Lengthy table referenced here
US20100281003A1-20101104-T00002
Please refer to the end of the specification for access instructions.

As noted supra, HIPP interactions can be categorized according to their identified function as defined in the PDB (FIG. 5B). Some HIPP interactions could fall into more than one function category. A subset of HIPP interactions were categorized by function and each HIPP interaction was limited to one category (see Tables 3-16). Helical interfaces are involved in a wide distribution of functions ranging from enzymatic activity to protein associations. The largest category, energy metabolism and various enzymes, accounts for 34% of HIPP interactions. This category contains many hydrolases, oxidoreductases, and transferases, among other enzymes (Table 5). The protein synthesis and turnover category contains chaperones, proteosomes, ribosomes, and other proteins involved in protein synthesis (Table 10). The transcription category contains proteins that are either part of transcription regulation, such as activators or repressors, or are part of the transcription machinery, such as those that bind to DNA (Table 15). The DNA binding category contains proteins that target DNA but are not involved in transcription (Table 4).

The length of each helix participating in the interface of the identified complexes was also examined (see Table 2). Helix length was calculated as the total length of polypeptide chain that contained any interface residues. Thus, the full length of the helix, including residues that may not be part of the interface, were included. This analysis indicates that helices involved in protein interactions range from five residues to 113 residues. The number of helix residues directly engaged in binding has been assessed previously by examining 122 homodimers and 204 protein-protein heterocomplexes (Guharoy et al., “Secondary Structure Based Analysis and Classification of Biological Interfaces: Identification of Binding Motifs in Protein-Protein Interactions,” Bioinformatics 23:1909-1918 (2007), which is hereby incorporated by reference in its entirety). This study implicated an average helix length of seven residues in binding (Guharoy et al., “Secondary Structure Based Analysis and Classification of Biological Interfaces: Identification of Binding Motifs in Protein-Protein Interactions,” Bioinformatics 23:1909-1918 (2007), which is hereby incorporated by reference in its entirety). Together, these studies emphasize the short length of the helical domain involved in protein interactions.

This study reveals new classes of previously unidentified targets for helix mimetics. Some of the identified targets will potentially aid in drug discovery efforts. In this regard, it is interesting to note that this query identified a number of kinases that may be regulated by helix mimetics (see Table 6 above). In this collection, the secondary structures are helical structures. The specific amino acid interface residues comprising the helical structures at the interface of the two-chain inter-protein interactions are shown in Table 6.

Kinases are an important class of potential drug targets. Typical kinase inhibitors mimic ATP or substrate conformations. New types of scaffolds that can specifically regulate the function of therapeutically important kinases will fill an important gap in a medicinal chemist's repertoire (Fedorov et al., “Insights for the Development of Specific Kinase Inhibitors by Targeted Structural Genomics,” Drug Discov. Today 12:365-372 (2007), which is hereby incorporated by reference in its entirety). These scaffolds can be generated using the data provided in Tables 2, 6, and 17.

In summary, a collection of helical interfaces in protein-protein interactions have been identified and analyzed using various computer executable codes and scripts. This study was undertaken to address the significant chasm in the elegant design of helix mimetics and their sporadic use in biology. This study provides an extensive list of potential targets for the emerging classes of helix mimetics.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

LENGTHY TABLES
The patent application contains a lengthy table section. A copy of the table is available in electronic form from the USPTO web site (http://seqdata.uspto.gov/?pageRequest=docDetail&DocID=US20100281003A1). An electronic copy of the table will also be available from the USPTO upon request and payment of the fee set forth in 37 CFR 1.19(b)(3).

What is claimed:

1. A method of generating a database of protein secondary structures that are at an interface of a two-chain inter-protein interaction said method comprising:
retrieving, from a protein database, multi-entity protein structures having one or more inter-chain interactions;
extracting, from the retrieved multi-entity protein structures, two-chain protein structures;
distinguishing the extracted two-chain protein structures having inter-protein interactions from the extracted two-chain protein structures having only intra-protein interactions;
identifying the distinguished two-chain inter-protein interactions that comprise a protein secondary structure at their interface; and
storing in a memory storage device the protein secondary structures at an interface of the identified two-chain inter-protein interactions.

2. The method according to claim 1, further comprising:
classifying the identified two-chain inter-protein interactions by biological function.

3. The method according to claim 1, further comprising:
removing, prior to storing, any redundant two-chain inter-protein interactions from the identified two-chain inter-protein interactions that comprise a protein secondary structure at their interface.

4. The method according to claim 1, further comprising:
querying the protein data base at various time intervals to identify one or more additional multi-entity protein structures;
repeating the retrieving, extracting, distinguishing, and identifying steps;
identifying any non-redundant secondary structures at an interface of a two-chain inter-protein interaction; and
storing the identified non-redundant secondary structures in the memory storage device.

5. The method according to claim 1, wherein the protein secondary structure comprises a helical structure.

6. The method according to claim 1, wherein the protein secondary structures comprise a β-strand structure.

7. The method according to claim 1, wherein the protein secondary structures comprise a β-turn structure.

8. The method according to claim 1, wherein said identifying comprises:
measuring φ and φ angles of at least four contiguous amino acid residues of each chain of the two-chain inter-protein interactions; and
identifying secondary structures present at an interface of the two-chain inter-protein interactions based on said measuring.

9. The method according to claim 1, wherein said identifying comprises:
identifying interface amino acid residues of at least one of the identified two-chain inter-protein interactions.

10. The method according to claim 9, wherein said identifying interface amino acid residues comprises:
identifying an amino acid residue in one chain of an identified two-chain inter-protein interaction having at least one atom within a 5 Å radius of an atom in the other chain of the identified two-chain inter-protein interaction.

11. The method according to claim 9, wherein said identifying interface amino acid residues comprises:
measuring density of C_{β} atoms surrounding a C_{β} atom of an amino acid residue in one chain of an identified two-chain inter-protein interaction; and
identifying interface amino acid residues based on said measuring.

12. The method according to claim 9 further comprising:
determining which of the identified interface amino acid residues are hot spot amino acid residues.

13. The method according to claim 12, wherein said determining is carried out using an amino acid mutagenesis analysis.

14. A computer readable medium having stored thereon instructions that when executed by a processor generate a database of protein secondary structures that are at an interface of a two-chain inter-protein interaction, the computer readable medium having residing thereon machine executable code that when executed by at least one processor, causes the processor to perform steps comprising:
retrieving, from a protein database, multi-entity protein structures having one or more inter-chain interactions;
extracting, from the retrieved multi-entity protein structures, two-chain protein structures;
distinguishing the extracted two-chain protein structures having inter-protein interactions from the extracted two-chain protein structures having only intra-protein interactions;
identifying the distinguished two-chain inter-protein interactions that comprise a protein secondary structure at their interface; and
storing in a memory storage device the protein secondary structures at an interface of the identified two-chain inter-protein interactions.

15. The medium according to claim 14, wherein the machine executable code further contains instructions for:
classifying the identified two-chain inter-protein interactions by biological function.

16. The medium according to claim 14, wherein the machine executable code further contains instructions for:
removing, prior to storing, any redundant two-chain inter-protein interactions from the identified two-chain inter-protein interactions that comprise a protein secondary structure at their interface.

17. The medium according to claim 14, wherein the machine executable code further contains instructions for:
querying the protein data base at various time intervals to identify one or more additional multi-entity protein structures;
repeating the retrieving, extracting, distinguishing, and identifying steps;
identifying any non-redundant secondary structures at an interface of a two-chain inter-protein interactions; and
storing the identified non-redundant secondary structures in the memory storage device.

18. The medium according to claim 14, wherein the protein secondary structure comprises a helical structure.

19. The medium according to claim 14, wherein the protein secondary structures comprise a β-strand structure.

20. The medium according to claim 14, wherein the protein secondary structures comprise a β-turn structure.

21. The medium according to claim 14, wherein said identifying comprises:
measuring φ and φ angles of at least four contiguous amino acid residues of each chain of the two-chain inter-protein interactions; and
identifying secondary structures present at an interface of the two-chain inter-protein interactions based on said measuring.

22. The medium according to claim 14, wherein said identifying comprises:
identifying interface amino acid residues of at least one of the identified two-chain inter-protein interactions.

23. The medium according to claim 22, wherein said identifying interface amino acid residues comprises:
identifying an amino acid residue in one chain of an identified two-chain inter-protein interaction having at least one atom within a 5 Å radius of an atom in the other chain of the identified two-chain inter-protein interaction.

24. The medium according to claim 22, wherein said identifying interface amino acid residues comprises:
measuring density of C_{β} atoms surrounding a C_{β} atom of an amino acid residue in one chain of an identified two-chain inter-protein interaction; and
identifying interface amino acid residues based on said measuring.

25. The medium according to claim 22 further comprising:
determining which of the identified interface amino acid residues are hot spot amino acid residues.

26. The medium according to claim 25, wherein said determining is carried out using an amino acid mutagenesis analysis.

27. A system for generating a database of protein secondary structures that are at an interface of a two-chain inter-protein interaction, the system comprising:
a retrieval module that retrieves, from a protein database stored on a memory storage device, multi-entity protein structures having one or more inter-chain interactions;
an extraction module that extracts, from the retrieved multi-entity protein structures, two-chain protein structures;
a distinguishing module that distinguishes the extracted two-chain protein structures having inter-protein interactions from the extracted two-chain protein structures having only intra-protein interactions;
an identification module that identifies the distinguished two-chain inter-protein interactions that comprise a protein secondary structure at their interface; and
a storage module for storing to a memory storage device the protein secondary structures at an interface of the identified two-chain inter-protein interactions.

28. The system according to claim 27, further comprising:
a classification module that classifies the identified two-chain inter-protein interactions by biological function.

29. The system according to claim 27, further comprising:
a removal module that removes, prior to storing, any redundant two-chain inter-protein interactions from the identified two-chain inter-protein interactions that comprise a protein secondary structure at their interface.

30. The system according to claim 27, wherein the secondary structures comprise a helical structure.

31. The system according to claim 27, wherein the secondary structures comprise a β-strand structure.

32. The system according to claim 27, wherein the secondary structures comprise a β-turn.

33. The system according to claim 27, wherein the identification module is configured to measure φ and φ angles of at least four contiguous amino acid residues of each chain of the two-chain inter-protein interactions and identify secondary structures present at an interface of the two-chain inter-protein interactions based on the measured angles.

34. The system according to claim 27, wherein the identification module is configured to identify interface amino acid residues of at least one of the identified two-chain inter-protein interactions.

35. The system according to claim 34, wherein the identification system is configured to identify an amino acid residue in one chain of an identified two-chain inter-protein interaction having at least one atom within a 5 Å radius of an atom in the other chain of the identified two-chain inter-protein interaction.

36. The system according to claim 34, wherein the identification system is configured to measure density of C_{β} atoms surrounding a C_{β} atom of an amino acid residue in one chain of an identified two-chain inter-protein interaction and identify interface amino acid residues based on the measured density.

37. The system according to claim 34 further comprising:
a module for determining which of the identified interface amino acid residues are hot spot amino acid residues.

38. The system according to claim 37, wherein the system for determining which of the identified interface amino acid residues are hot spot amino acid residues is configured to carry out an amino acid mutagenesis analysis.

39. The system according to claim 27, further comprising:
a query module that queries the protein data base at various time intervals to identify one or more additional multi-entity protein structures, and
a comparison module that compares the identified secondary structures at an interface of a two-chain inter-protein interaction to identify non-redundant secondary structures.

40. A collection of isolated protein secondary structures that are at an interface of a two-chain inter-protein interaction, wherein the collection contains about 1%, about 5%, about 10%, about 20%, about 40%, about 60%, about 80%, or about 100% of the isolated protein secondary structures of Table 2.

41. The collection according to claim 40, wherein the collection contains m through n secondary structures, where m and n are integers and n is greater than m.

42. The collection according to claim 41, wherein m is an integer selected from the group consisting of 2, 4, 8, 10, 50, 100, 200, 300, 400, 500, 600, 700, 800, 900, 1000, 1500, 2000, 2500, 3000, 3500, 4000, 4500, and 5000; and n is an integer selected from the group consisting of 10, 15, 50, 100, 200, 300, 400, 500, 600, 700, 800, 900, 1000, 1500, 2000, 2500, 3000, 3500, 4000, 4500, 5000, 5500, 6000, 6500, 7000, 7500, 8000, 8500, 9000, and 10000.

43. The collection according to claim 40, wherein the collection is a collection of helical protein secondary structures.

44. The collection according to claim 40, wherein the collection is a collection of protein secondary structures potentially involved in modulating cell cycle.

45. The collection according to claim 40, wherein the collection is a collection of protein secondary structures potentially involved in modulating DNA binding.

46. The collection according to claim 40, wherein the collection is a collection of protein secondary structures potentially involved in modulating energy metabolism and/or enzymatic activity.

47. The collection according to claim 40, wherein the collection is a collection of protein secondary structures potentially involved in modulating immune system function.

48. The collection according to claim 40, wherein the collection is a collection of protein secondary structures potentially involved in modulating cell membrane proteins and/or receptor interactions.

49. The collection according to claim 40, wherein the collection is a collection of helical protein secondary structures potentially involved in modulating protein binding or have an unknown function.

50. The collection according to claim 40, wherein the collection is a collection of protein secondary structures potentially involved in modulating protein synthesis and/or turnover.

51. The collection according to claim 40, wherein the collection is a collection of protein secondary structures potentially involved in modulating RNA binding.

52. The collection according to claim 40, wherein the collection is a collection of protein secondary structures potentially involved in modulating cell signaling.

53. The collection according to claim 40, wherein the collection is a collection of protein secondary structures potentially involved in modulating cellular structure and/or cellular adhesion.

54. The collection according to claim 40, wherein the collection is a collection of protein secondary structures potentially involved in modulating gene transcription.

55. The collection according to claim 40, wherein the collection is a collection of protein secondary structures potentially involved in modulating cellular transport.

56. The collection according to claim 40, wherein the collection is a collection of protein secondary structures that are from toxins, viruses, or bacteria.

57. A method of identifying a therapeutic drug candidate potentially effective in modulating a two-chain inter-protein interaction having a secondary structure at its interface, said method comprising:
providing a therapeutic drug candidate;
selecting a protein secondary structure from the collection according to claim 40;
providing an agent, wherein the agent mimics the protein secondary structure;
contacting the therapeutic drug candidate with the agent under conditions effective for the therapeutic drug candidate to bind to the agent; and
detecting whether any binding occurs between the therapeutic drug candidate and the agent, wherein binding between the therapeutic drug candidate and the agent indicates that the therapeutic drug candidate is potentially effective in modulating a two-chain inter-protein interaction having the protein secondary structure at its interface.

58. A method of identifying a therapeutic drug candidate potentially effective in modulating a two-chain inter-protein interaction having a secondary structure at its interface, said method comprising:
selecting a protein secondary structure from the collection according to claim 40;
providing a therapeutic drug candidate, wherein the drug candidate mimics the protein secondary structure;
providing at least one protein of a two-chain inter-protein interaction having the protein secondary structure at its interface;
contacting the therapeutic drug candidate with the at least one protein under conditions effective for the therapeutic drug candidate to bind to the at least one protein; and
detecting whether any binding occurs between the therapeutic drug candidate and the at least one protein, wherein binding between the therapeutic drug candidate and the at least one protein indicates that the therapeutic drug candidate is potentially effective in modulating the two-chain inter-protein interaction.

59. The method according to claim 57, wherein said contacting is carried out in vitro.

60. The method according to claim 57, wherein said contacting is carried out ex vivo.

61. The method according to claim 57, wherein said contacting is carried out in vivo.
